(19) United States
(12) Patent Application Publication
(10) Pub. No.: US 2011/0264870 A1
(43) Pub. Date: Oct. 27, 2011

(54) Using region status array to determine write barrier actions

(75) Inventor: Tatu J. Ylonen, Espoo (FI)

(73) Assignee: TATU YLONEN OY LTD, Espoo (FI)

(21) Appl. No.: 13/091,233

(22) Filed: Apr. 21, 2011

Related U.S. Application Data
(60) Provisional application No. 61/327,374, filed on Apr. 23, 2010.

(51) Int. Cl. G06F 12/00

(52) U.S. Cl. 711/154; 711/E12.001

(57) ABSTRACT

A fast method for determining which actions to take in a write barrier in a concurrent garbage collector is described. A region status array indexed by a region index computed from the written address is used for determining the status of the region containing the written object and for selecting, in part, the actions taken by the write barrier. By carefully manipulating the region status array, various operations and changes in write barrier actions can be performed very efficiently.

### CROSS-REFERENCE TO RELATED APPLICATIONS

This application claims the benefit of prior-filed provisional application No. 61/327,374, filed Apr. 23, 2010, which is hereby incorporated herein in its entirety.

This application is related to the U.S. patent application Ser. No. 12/772,496 filed Mar. 3, 2010, Ser. No. 12/774,136 filed May 5, 2010, and Ser. No. 13/090,643 filed Apr. 20, 2011, which are hereby incorporated herein in their entirety.

### INCORPORATION-BY-REFERENCE OF MATERIAL SUBMITTED ON ATTACHED MEDIA

Not Applicable

### TECHNICAL FIELD

The invention relates to automatic memory management, particularly to garbage collection, in data processing and distributed systems.

### BACKGROUND OF THE INVENTION

Modern garbage collectors scale well to memory sizes of several gigabytes. A well-known modern collector providing soft real-time operation (approximately 50 ms pause times) for fairly large memories is D. Detlefs et al: Garbage-First Garbage Collection, ISMM'04, pp. 37-48, ACM, 2004.

Another recent garbage collector is S. Liu et al: Packer: an Innovative Space-Time-Efficient Parallel Garbage Collection Algorithm Based on Virtual Spaces, IEEE International Symposium on Parallel&Distributed Processing, IEEE, 2009.

In many applications it is desirable to obtain even shorter pause times. F. Pizlo et al: STOPLESS: A Real-Time Garbage Collector for Multiprocessors, ISMM'07, pp. 159-172, ACM, 2007 describes a garbage collector for real-time applications with very short pause times, implemented using soft synchronization and using wide objects for copying. It uses a read barrier to coordinate access to old and new copies of objects.

The verb copy is used in this description mostly in its technical garbage collection sense, which usually includes the notion of moving an object to a new location in memory by copying it and then eventually (not necessarily immediately) freeing the original.

The following articles provide additional implementation details on soft synchronization, the use of sliding views, and the general implementation of a real-time garbage collector:
H. Azatchi and E. Petrank: Integrating Generations with Advanced Reference Counting Garbage Collectors, CC'03 (Compiler Construction), Lecture Notes in Computer Science 2622, pp. 185-199, Springer, 2003
H. Azatchi et al: An On-the-Fly Mark and Sweep Garbage Collector Based on Sliding Views, OOPSLA'03, ACM, 2003
Y. Levanoni and E. Petrank: An On-the-Fly Reference Counting Garbage Collector for Java, OOPSLA'01, pp. 367-380, ACM, 2001
D. Doligez and X. Leroy: A concurrent, generational garbage collector for a multithreaded implementation of ML, POPL'93, pp. 113-123, ACM, 1993
D. Doligez and G. Gonthier: Portable, Unobtrusive Garbage Collection for Multiprocessor Systems, POPL'94, pp. 70-83, ACM, 1994
T. Yuasa: Real-Time Garbage Collection on General-Purpose Machines, J. Systems Software, 11:181-198, Elsevier, 1990
D. Detlefs: A Hard Look at Hard Real-Time Garbage Collection, 7th International Symposium on Object-Oriented Real-Time Distributed Computing (ISORC'04), IEEE, 2004.

Various alternative approaches to copying objects in real-time collectors are presented in the following patent application publications:
US 2008/0281886 A1 (Petrank et al), Nov. 13, 2008: Concurrent, lock-free object copying
US 2009/0222494 A1 (Pizlo et al), Sep. 3, 2009: Optimistic object relocation
US 2009/0222634 A1 (Pizlo et al), Sep. 3, 2009: Probabilistic object relocation.

U.S. Pat. No. 6,671,707 (Hudson et al), Dec. 30, 2003 (Method for practical concurrent copying garbage collection offering minimal thread block times) teaches a method for concurrent copying garbage collection offering minimal thread blocking times without the use of read barriers. In their method, mutators may access and modify both the old and new copy of a modified object simultaneously, and a special write barrier is used for propagating writes from one copy to the other. In at least one embodiment, they use an atomic compare-and-swap instruction for installing a forwarding pointer in a copied object. Their object copying operation (FIG. 4E) uses an extra read, comparison, and a compare-and-swap operation for each copied memory word, which is a significant overhead over standard copying (a compare-and-swap instruction can cost up to about a hundred times the processing time and memory bandwidth of a normal pipelined burst-mode memory write). A related academic paper is R. Hudson and J. E. B. Moss: Sapphire: Copying GC Without Stopping the World, JAVA Grande/ISCOPE'01, pp. 48-57, ACM, 2001.

The Hudson&Moss method has been further developed in T. Kalibera: Replicating Real-Time Garbage Collector for Java, JTRES'09, pp. 100-109, ACM, September 2009.

Background information on garbage collection can be found in the book R. Jones and R. Lins: Garbage Collection: Algorithms for Dynamic Memory Management, Wiley, 1996. The book provides a good overview of garbage collector implementation techniques, and is a widely used textbook in the art.

Known real-time garbage collection algorithms are based on a tight coupling between synchronizing mutator accesses and performing garbage collection, particularly copying. Typically, a read barrier must be used by mutators for coordinating concurrent accesses to objects being moved. Known real-time garbage collectors running mutators concurrently with garbage collection have been relatively small-scale, whereas known large-memory collectors perform garbage collection during evacuation pauses, and mutators are stopped for the duration of the evacuation pause.

The number of processing cores in modern processors (as well as the number of processors in high-end computers) has increased significantly in recent years, and frequently the problem is more making use of all available cores than the availability of processing power. Stopping all mutators for garbage collection introduces a sequential element to the application, reducing the maximum speedup obtainable by using multiple processors (Amdahl's law). It would thus be desirable to run garbage collection in parallel with mutators also in systems with very large memories.

Distributed garbage collection has been investigated for a long time (see, e.g., B. Liskov and R. Ladin: Highly-available distributed services and fault-tolerant distributed garbage collection, 5th Symposium on Principles of Distributed Computing, pp. 29-39, ACM, 1986). Several widely deployed platforms, including Microsoft® .NET and various Java environments, implement distributed garbage collection.

Practical applications of distributed garbage collection have been relatively small-scale, often with only thousands to tens of thousands of objects. Future semantic computing applications, knowledge processing systems, and social networking applications may contain many billions of objects, shared on potentially thousands of computers/nodes, in an address space spanning terabytes or petabytes. It would be desirable to make garbage collection, including distributed garbage collection, scale to such systems. Sufficiently scalable, sufficiently real-time garbage collection is one of the key enabling technologies for such systems.

Surveys of distributed garbage collection algorithms can be found in S. Abdullahi et al: Garbage Collecting the Internet: A Survey of Distributed Garbage Collection, ACM Computing Surveys, 30(3):330-373, 1998 and S. Brunthaler: Distributed Garbage Collection Algorithms, Seminar Garbage Collection, Institute for Systemsoftware, January 2006. The references contained therein provide extensive information on general implementation techniques for distributed garbage collection.

Some recent references for distributed garbage collection include:
L. Veiga and P. Ferreira: Asynchronous, Complete Distributed Garbage Collection, Technical Report RT/11/2004, INESC-ID/IST, Lisboa, Portugal, June 2004 (Updated 2005)
L. Veiga and P. Ferreira: Asynchronous Complete Distributed Garbage Collection, Proc. 19th IEEE International Parallel and Distributed Processing Symposium (IPDPS'05), IEEE, 2005
S. Norcross et al: Implementing a Family of Distributed Garbage Collectors, ACSC2003, Australian Computer Society, 2003.

Many modern distributed object systems use stubs/scions or delegates for representing remote objects, and pass method invocations on objects to remote nodes using RPC (Remote Procedure Call). However, in high-performance semantic computing applications it is important to replicate data and perform operations on local copies highly efficiently (including updates to some objects). For performance reasons, it may not be desirable to go through delegates and use RPC for all object accesses in such systems.

Many distributed garbage collectors do not support object migration from one node to another in the distributed system. Permitting migration would be highly desirable, as it allows more flexibility in clustering related objects, and such clustering is very important when the size of the database exceeds the available memory and a large part of the database is only available on disk (the databases in some future semantic search systems and knowledge processing systems might extend to petabytes). Clustering is also very important for fast start-up of such systems.

Distributed shared memory refers to systems where several computers that do not have hardware shared memory share a single address space accessible to software running on each of the nodes. In effect, it creates an illusion of a shared memory for application programs. Extensive research on distributed shared memory took place in the 1990's. Some references include:
M. Shapiro and P. Ferreira: Larchant-RDOSS: a Distributed Shared Persistent Memory and its Garbage Collector, WDAG'95 (9th International Workshop on Distributed Algorithms), pp. 198-214, Lecture Notes in Computer Science 972, Springer, 1995
J. Protic et al: A Survey of Distributed Shared Memory Systems, 28th Hawaii International Conference on System Sciences (HICSS'95), pp. 74-84, 1995
R. Kordale et al: Distributed/concurrent garbage collection in distributed shared memory systems, 3rd International Workshop on Object Orientation in Operating Systems, pp. 51-60, IEEE, 1993.

Distributed shared memory allows replication of objects to several nodes, and some distributed shared memory systems implement fine-grained synchronization of updates (frequently in connection with the implementation of distributed mutual exclusion algorithms and/or distributed memory barrier operations).

All of the above referenced patent documents, non-patent literature and books are hereby incorporated herein by reference in their entirety.

As garbage collectors grow in complexity and as more and more actions need to be implemented or triggered for various objects by a write barrier, and as such actions often depend on the object written into, the old and/or new values of the written memory location, and on the time when the write occurs relative to a garbage collection cycle running concurrently, the cost of the write barrier threatens to become substantial. An object of the present invention is to reduce the cost of the write barrier and make it more efficient to determine the actions to be taken when a write to a particular object occurs at a particular time.

### BRIEF SUMMARY OF THE INVENTION

A first aspect of the invention is a method of implementing a write barrier for an application supported by a garbage collector that supports multiple independently collectable memory regions, comprising:
computing, in a write barrier operation performed by a processor, a region index for the memory region containing an object from a pointer to the object;
reading a region status from a region status array using the region index to select which region's status is read; and
using the region status to determine further actions taken by a write barrier.

A second aspect of the invention is an apparatus comprising:
a region status array stored in a memory device, the region status array permitting a region status to be read from it using a region index to select which region status to read;
a processor implementing a write barrier, the write barrier configured to compute a region index from a written address and connected to the region status array for reading the region status corresponding to a region index; and
at least one write barrier action element connected to the write barrier and activated by the region status matching a predetermined value, the action element selected from the group consisting of:
   a write tracker for triggering re-copying of objects that have been written into during copying;
   a write tracker for triggering a liveness analyzer to trace the old value of a written memory location; and
   a write tracker for triggering a pointer in the nursery pointing to an object being copied to be updated to point to the new copy of the object.

A third aspect of the invention is a computer program product comprising:
computer executable instructions stored on a non-transitory computer-readable medium for computing a region index from a pointer to an object;
computer executable instructions stored on a non-transitory computer-readable medium for reading a region status from a region status array using the region index; and
computer executable instructions stored on a non-transitory computer-readable medium for using the region status to determine further actions taken by a write barrier.

A further aspect of the invention is a soft real-time incremental concurrent garbage collector that runs mostly concurrently with mutators with very short pause times. The disclosed garbage collector may be particularly well adaptable to systems with very large memory, and is also adaptable to distributed object systems (including those utilizing distributed shared memory). Such a garbage collector is expected to be important in, e.g., knowledge processing systems, semantic search, and large social networking systems.

Another aspect of the invention is that mutators do not see new copies of objects being copied until they are atomically switched to use them. A further aspect of this is implementing atomic switch in a distributed environment.

A further aspect of the invention is that copying is performed by copying the objects to be copied, tracking writes to them, and re-copying any objects that have been written into. Further embodiments of this aspect include atomically (with respect to mutators) switching to use the new copies, the use of a final re-copy, and the implementation of re-copying in a distributed environment.

A further aspect of the invention is the use of a write barrier for tracking which objects have been written into, and using that information for triggering re-copy.

A further aspect of the invention is performing the copying without using any atomic instructions for synchronizing the copying (except what may be needed for soft synchronization).

A further aspect of the invention is the way remembered sets are updated using several soft synchronizations. Further embodiments of this aspect include using a bitmap for representing external pointers and the use of the bitmap, maintenance of remembered sets in a distributed system, sending copy locators to remote nodes, and requesting the new address of a copied object from a remote node.

A further aspect of the invention is the use of the copy planner to cluster objects to copy while mutators are running in parallel. A further aspect is separating copy planning from liveness analysis and/or copying. A further aspect is the use of tree-like subgraphs as the unit of copy planning.

A further aspect is the use of graph partitioning for constructing distinguished subgraphs.

A further aspect is the use of graph partitioning for clustering objects into regions.

A further aspect of the invention is requesting permission from another node to copy a region or object. A variation of this aspect is proposing to another node to copy an object or region. These aspects relate to migration of objects.

A further aspect of the invention is implementing concurrent copying garbage collection on a general-purpose computer without a read barrier.

A further aspect of the invention is thread-local hash table based write barrier buffers for implementing sliding views. It may be combined with saving the buffers in a queue and processing them in the background after the mutator(s) have continued execution.

A further aspect of the invention is the effective decoupling of synchronization needs for mutators and for the garbage collector, eliminating read barriers, simplifying the write barrier, and allowing almost any copying garbage collector to be used with relatively minor adaptations.

A further aspect of the invention is switching nursery in first soft synchronization, and the use of a write barrier to track writes to the new nursery with values that refer to copied objects.

A further aspect of the invention is the use of a status array for determining whether a write should be recorded in a write barrier buffer.

A further aspect of the invention is the use of a bitmap for determining whether a write should be recorded in a write barrier buffer.

A further aspect of the invention is the use of a stand-alone remembered set update cycle for speeding up the next garbage collection cycle.

A further aspect of the invention is copying the global tracing mark for objects that are copied and/or re-copied.

A further aspect of the invention is using repeated soft synchronizations for obtaining more roots, until no more new roots are added by any thread.

A further aspect of the invention is distributed root extraction and liveness analysis using soft synchronization.

A further aspect of the invention is storing the call site with objects in the nursery, and using it for clustering during copy planning.

A further aspect of the invention is reusing free regions for the global tracer stack, reducing the amount of memory that must be reserved specifically for global tracing.

The various aspects of the invention might be claimed, e.g., as a method, an apparatus, a computer program product, or a data structure.

The benefits of the various embodiments of the present invention can include, but are not limited to:
reducing the overhead of a write barrier even if the actions to be performed by the write barrier depend on the object written, the new value written, and/or the time of the write relative to a concurrently running garbage collection cycle;
allowing an arbitrary set of regions to be included in a garbage collection cycle, while allowing the write barrier to identify writes to objects being copied in constant time;
allowing nursery to be spread among an arbitrary set of ordinary regions, eliminating the separate reservation of space for the nursery and allowing the nursery to grow almost up to the maximum available free space;
allowing generations to be spread arbitrarily in fixed-size memory regions, with constant write barrier overhead;
fast identification of pointers referring to popular objects (for which no remembered sets need to be maintained);
during tracing in liveness analysis, fast identification of whether a pointer points to a region of interest or outside it;
in a garbage collected distributed shared memory system, the region status array allows the write barrier to quickly determine whether a write needs to be propagated to another node in the distributed system;
with a cached region status array, eliminating memory bus overhead from accessing region status; and
fast identification of pointers pointing to objects being copied.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages or provide any or all of the benefits noted in any part of this disclosure.

### BRIEF DESCRIPTION OF THE SEVERAL VIEWS OF THE DRAWING(S)

FIG. 1 illustrates an apparatus or computer embodiment showing various components relevant for the invention.

FIG. 2 illustrates a garbage collection cycle in an embodiment of the invention.

FIG. 3 illustrates conservatively extracting a root set in an embodiment of the invention.

FIG. 4A illustrates analyzing live objects in an embodiment of the invention.

FIG. 4B illustrates pushing a root to a stack of the liveness analyzer in an embodiment of the invention.

FIG. 5 illustrates copying a subset of the live objects in an embodiment of the invention.

FIG. 6 illustrates re-copying in an embodiment of the invention.

FIG. 7 is a diagram illustrating the timing of various operations in an embodiment of the invention.

FIG. 8 illustrates updating references in an embodiment of the invention.

FIG. 9 illustrates a remembered set data structure in an embodiment of the invention.

FIG. 10 illustrates using a region status array to determine actions taken by a write barrier in an embodiment.

### DETAILED DESCRIPTION OF THE INVENTION

A family of garbage collectors and various related components, methods, and techniques are described herein. It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, a computing system, or a computer program product which is an aspect of the invention may comprise any number of the embodiments, elements, or alternatives of the invention described in this specification. Separate references to “an embodiment” or “one embodiment” refer to particular embodiments or classes of embodiments (possibly different embodiments in each case), not necessarily all possible embodiments of the invention. The subject matter described herein is provided by way of illustration only and should not be construed as limiting.

The garbage collector(s) described herein are primarily intended for use in systems with very large memories. They can be used in providing soft real-time operation with very short pause times for practical applications.

The garbage collector(s) are intended to run (mostly) concurrently with mutators. Preferably, copying is performed in parallel with mutators, substantially without using read barriers in the mutators, substantially without using atomic instructions either in the mutators or in the garbage collector, and with only minimal overhead in the write barrier. In some embodiments of the invention, during copying, mutators only see and modify the original objects. Rather than using a read barrier to determine which objects have been copied and direct accesses and updates by mutators to the correct copy in each case, a write barrier is used for tracking which objects may have been modified after copying, and such objects (or the relevant parts thereof) are re-copied. In some embodiments, a very brief stop-the-world pause (when all mutator threads are stopped) is used for atomically doing a final re-copy and switching mutators to use the new copies. Otherwise, only soft synchronizations are needed (i.e., mutators need not stop simultaneously). Since nearly all garbage collection work is moved away from the stop-the-world pause, it can be kept very short.

It turns out that doing copying in this manner permits convenient separation of mutator processing and the garbage collector, and scales to distributed systems much better than any known prior solutions to copying concurrently with mutator execution.

### Illustrative Computing System/Apparatus Embodiment

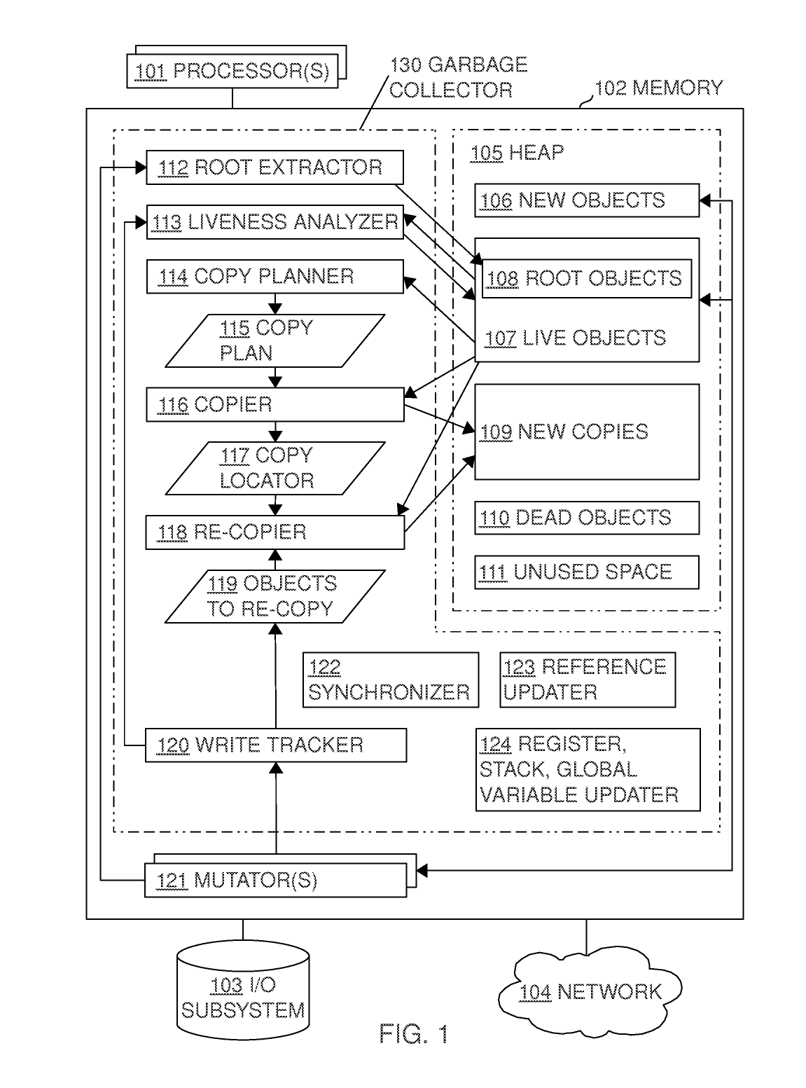

FIG. 1 illustrates a computing system and/or apparatus embodiment of the invention. The computing system comprises one or more processors (101) attached to a memory (102), either directly or indirectly, using a suitable bus architecture as is known in the art. The system also comprises an I/O subsystem (103), which often comprises non-volatile storage (such as disks, tapes, solid state disks, or other memories) and user interaction devices (such as a display, keyboard, mouse, touchpad or touchscreen, speaker, microphone, camera, acceleration sensors, etc). It often also comprises one or more network interfaces or an entire network (104) used to connect to other computers, the Internet, and to other nodes in a distributed computing system. Any network or interconnection technology may be used, such as wireless communications technologies, optical networks, ethernet, and/or InfiniBand®.

The processors may be individual physical processors, co-processors, specialized state machines, or processing cores within a single chip, module, ASIC, or system-on-a-chip. Preferably they are 64-bit general purpose processors, such as Intel® Xeon® X7560 or AMD® 6176SE, or more precisely cores therein. The memory in present day computers is typically semiconductor DRAM (e.g., DDR3 DIMMs), but other technologies may also be used (including non-volatile memory technologies).

A computer may be any general or special purpose computer, workstation, server, laptop, handheld device, smartphone, wearable computer, embedded computer, a system of computers (e.g., a computer cluster, possibly comprising many racks or machine rooms of computing nodes and possibly utilizing distributed shared memory), distributed computer, computerized control system, processor, chip, or other apparatus capable of performing data processing.

A computing system may be a computer, a cluster of computers, a computing grid, a distributed computer, or an apparatus capable of performing data processing (e.g., robot, vehicle, control system, instrument, game, toy, home appliance, or office appliance). It may also be an OEM component or module, such as a natural language interface for a larger system. The functionality described herein might be divided among several such modules.

An apparatus that is an aspect of the invention may contain various additional components that a skilled person would know belong to such an apparatus in each application. Examples include sensors, cameras, microphones, radar, ultrasound sensors, displays, manipulators, wheels, hands, legs, wings, rotors, joints, motors, engines, conveyors, control systems, drive trains, propulsion systems, enclosures, support structures, hulls, fuselages, power sources, batteries, light sources, instrument panels, graphics processors, co-processors, front-end computers, tuners, radios, infrared interfaces, remote controls, circuit boards, connectors, cabling, etc. Various examples illustrating the components that typically go in each kind of apparatus can be found in US patents as well as the open technical literature in the related fields, and are generally known to one skilled in the art or easily found out from public sources. The invention can generally lead to improved user interfaces, more attractive interaction, higher performance, better control systems, more intelligence, and improved overall competitiveness in a broad variety of apparatuses, without requiring substantial changes in components other than the higher-level control/interface systems that perform data processing.

Various components relevant to one or more embodiments of the present invention that are illustrated in FIG. 1 may be implemented as computer executable program code means residing in tangible computer-readable memory. However, they may also be implemented fully or partly in hardware, for example, as a part of a processor, as a co-processor, or as additional components or logic circuitry in an ASIC or a system-on-a-chip. They may also be implemented using, e.g., emulation, interpretation, just-in-time compilation, or a virtual machine.

The heap (105) is a memory area used for storing objects that can be accessed and modified by mutators (121). A mutator is a thread (or other suitable abstraction) executing application code, and usually writing to (i.e., mutating) objects in the heap. It may be implemented, e.g., as an operating system thread time-shared on the processor(s), as a dedicated processor core, or as a hardware or software state machine. It may also employ emulation, just-in-time compilation, or an interpreter (as in, e.g., many Java virtual machines).

The heap comprises various sub-areas or regions in many embodiments. The term region is used herein to refer to a memory area that can be garbage collected independently of (most) other memory areas. New objects (106) illustrate a region where new objects are allocated by mutators (it may consist of several memory regions that are not necessarily contiguous and may be dynamically extended). In the description below, it also illustrates new objects created by mutators while the garbage collector is executing. This area is often called the nursery.

Live objects (107) illustrate objects that are (or may be) accessible to mutators and may be read or modified by mutators (in addition to the new objects). In a distributed system some of the objects may reside on other nodes (i.e., on other computers that are part of the computing system), and there may be a copy of some objects on more than one node (i.e., they may be replicated). Some remote objects may be represented by stubs or delegates in some embodiments, as is known in the art.

The live objects include root objects (108), which are objects (potentially) referenced from global variables, registers, stack slots, and other memory locations that are inherently accessible. The root set, i.e., the set of root objects, is (conservatively) extracted at the start of each garbage collection cycle. Since the root and live object sets are conservative, they may sometimes include objects that are not actually reachable; however, the system tries to ensure that such objects eventually get freed.

The new copies (109) are copies of live objects made during garbage collection. They are normally not accessible to mutators, until the finalization phase described herein switches mutators to see (only) the new copies for the copied objects, at which time they become part of the live objects and their old versions normally become part of the dead objects.

The dead objects (110) represent objects that are known to no longer be accessible to mutators. Such objects can usually be freed. Usually any detected dead objects are freed before the end of each garbage collection cycle (making the space used by them free and part of the unused space).

The unused space (111) illustrates space in the heap that is currently unused. Such space can normally be used for allocation. Any known method can be used for allocating space, including freelists, TLABs (Thread-Local Allocation Buffers) and grouped space allocation. The allocation system may also try to cluster related objects.

The heap may also comprise other data, including metadata (such as remembered sets, various bitmaps, or forwarding pointers) in some embodiments. In many embodiments the heap may also comprise special memory areas for popular objects, constant objects, or large objects.

The garbage collector (130) performs automatic memory management for the benefit of the mutators. The garbage collector is preferably implemented as a background process that can execute concurrently with mutators. The garbage collector may be implemented as software instructions running on one or more threads, using a separate processor or co-processor, or in a combination of software and hardware logic.

The root extractor (112) illustrates a component that conservatively extracts the root objects (108) from the mutators and other data in the computing system. It may use, e.g., global variables, thread stacks, thread-local variables, remembered sets, scions, and/or external references reported by other nodes in a distributed computer system for identifying the roots. In some embodiments, the roots are extracted for only a subset of the heap, such as the nursery and/or those areas of old generations or those regions that will be garbage collected (together called the objects of interest or regions of interest herein). Sometimes, the root set will not be extracted separately, but its extraction is performed as part of or in parallel with the liveness analysis.

The liveness analyzer (113) illustrates a component for determining which objects are live, that is, accessible from the roots (note that the set of root objects can be conservative, including objects that are no longer live, and so can the set of live objects). In many embodiments, a garbage collection cycle performs liveness analysis for only a fraction of the heap at a time. Such a garbage collector might select, for example, a set of regions to be copied (the regions of interest), and could perform liveness analysis for only those regions and the nursery. Other parts of the heap would then typically not be affected by the garbage collection, except for referring pointer update.

The liveness analyzer is advantageously implemented so that it does not clobber (modify in a mutator-visible manner, or destroy) any live objects. The mutators may run concurrently with liveness analysis, and may access and modify the live objects during the liveness analysis. Mutators will execute faster if they do not need a read barrier, and therefore the objects are preferably not modified (in a manner visible to mutators) during the collection. The liveness analyzer may, e.g., mark live objects in a bitmap or in a reserved space in an object header. Advantageously, a write barrier is used for tracking which objects are written during root extraction and/or liveness analysis, and for collecting old values of any written memory locations that contain pointers. Such old values are then added to the live set, effectively implementing snapshot-at-the-beginning marking (SATB marking; see Yuasa (1990) or Detlefs et al (2004)).

The copy planner (114) illustrates a component for planning which objects to copy and where to copy them. It may choose to copy some, all, or none of the objects of interest. Mutators execute in parallel with it, and continue to use the write barrier to track writes. In some embodiments, the copy planner may be combined with the liveness analyzer or the copier (116), especially if all objects included in the live objects set are to be copied and no clustering is done or clustering is very simple. In some other embodiments, the copy planner may be quite complex, using, e.g., a graph partitioning algorithm to divide the live objects into subgraphs that are each copied to a different region or node, or made a different distinguished subgraph, minimizing the number of connections between subgraphs.

When a separate copy planner is utilized, it may produce a copy plan (115), which is a data structure designating which objects are to be copied. It may also describe which objects are to be copied such that they form a cluster. It may also include a concrete destination address for each object (or a tree of objects; see U.S. patent application Ser. No. 12/147,419 “Garbage Collection via Multiobjects”) in some embodiments. The copy plan may be stored by storing forwarding pointers for the objects to be copied (note: they may not yet have been copied at this stage, and might use a separate indicator to indicate when they have been copied). In other embodiments, the copy plan might be stored as a table, possibly arranged according to the destination region where the objects are to be copied or by the source address of the object (thereby improving locality in copying and thus its performance, and allowing the copying to be performed by a processor core residing on the same NUMA (Non-Uniform Memory Access) node as one or both of the source and destination regions).

In many embodiments large objects are stored separately from other objects, and large objects are never moved. Thus, the copy planner would usually not include large objects in the set of objects to be copied. However, nothing prevents moving large objects in much the same way as other objects.

If the liveness analyzer discovers trees of objects, such trees may advantageously be treated as single objects during copy planning in some embodiments. Then, the copy planner could use the trees as the unit in graph partitioning, speeding it up significantly.

The copy planner may also simply cluster objects based on their connectivity (i.e., pointers between objects or groups of objects), and may use connectivity between objects being copied and other objects to pull objects being copied into the same regions with objects referring to them from outside the regions of interest (even if such referring objects are not being copied), provided there is space in the region of the referring object. The copy planner may also seek to minimize the number of pointers between the resulting clusters, or the number of pointers between regions (which directly relates to the size of remembered sets). It may also seek to minimize the number of pointers from old generations to young generations (as in a generational garbage collector no remembered sets are usually maintained for references from younger generations to older generations; this would be a form of early promotion for objects pulled into older generations by such minimization). In a distributed system, the copy planner could seek to minimize references between nodes in a distributed system, attempting to copy objects or clusters to the node that has most references to/from the cluster (references between nodes are particularly expensive, as they result in both space overhead for remembered sets, stubs, and/or scions, and time overhead in fetching objects from remote nodes and costly updates). The copy planner may also try to cluster objects that were created at approximately the same time (i.e., have approximately the same age) into a particular set of regions (effectively forming a generation). Copy planning may also be affected by membership in tree-like subgraphs or distinguished subgraphs, as the copy planner may, for example, try to place such subgraphs in consecutive memory locations in the same region. Further, in a distributed system the copy planning might be affected by received requests or permissions from other nodes in the system to migrate the object between nodes.

The copier (116) is a component for copying live objects to new locations in the address space (to new copies (109)). It generally follows the copy plan (115); however, in some embodiments it may be integrated into the liveness analyzer (113) or the copy planner (114). In some embodiments the destination addresses for copies are decided by the copy planner; in others, they are decided by the copier. Space for the new objects may be allocated by the liveness analyzer, the copy planner, or the copier.

The copier stores the new addresses of objects in the copy locator (117), which may be a separate data structure or, e.g., a forwarding pointer for which space is reserved in the header of each object (or, equivalently, between objects). The copy locator may also be an array indexed by a value computed from the address of the object (e.g., “idx=(addr−base)/min_alignment”), or a set of such arrays, one for each contiguous memory area from which objects are being copied. Such arrays could contain, e.g., forwarding pointers (e.g., memory address of the corresponding new object, with uninitialized values for slots that do not correspond to the beginning of an object), or offsets to an allocation memory area, or an allocation memory area identifier and offset within the area. For example, a region number or index into a separate allocation region array could be stored in the more significant bits and an offset in the less significant bits of a 32-bit value. Alternatively, a hash table or some other index structure could be used for finding the new address of an object from the address of the object (or from an address within it in some embodiments). It is also possible to use a different data structure for the copy locator in the nursery and in older regions (for example, using a forwarding pointer between objects in the nursery, and a per-region array for objects in older regions).

The copy plan and copy locator may be the same data structure, in which case the copier may not need to modify it or construct a new copy locator data structure at all.

Those pointers within copied objects that refer to other copied objects are preferably updated during copying. For example, in embodiments where the destination address for each object is determined before copying, it is possible to iterate over each copied object, check for each pointer therein whether it points to another copied object (e.g., to a memory region included in copying), and if so, use the copy locator (117) to look up the new location of the referenced pointer. This could be done irrespective of whether the referenced object has already been copied, allowing very liberal parallelization of the copying. Such pointer updating could be done, e.g., after copying each object, or for a plurality of objects at a time after several objects have been copied, or for all copied objects at once after they have all been copied. It would also be possible to postpone such pointer update to the time when all threads are stopped, but doing it during copying and/or re-copying reduces the duration of the stop-the-world pause.

In embodiments where the address for each copied object is only determined when it is copied, the copying could be performed recursively, using a stack, as is customary in many copying collectors (see the book by Jones and Lins for examples). The new addresses for the copied objects could then be stored in the copy locator (e.g., forwarding pointer in object headers) as each object is copied. Such copying would perhaps be best suited for copying integrated with liveness analysis, with little or no planning involved. Such copying would need to handle cycles and shared data, unlike copying that has been fully planned in advance and where destination addresses have already been assigned in the planning or liveness analysis stages (in those cases cycles and shared data checking has already been handled at that stage).

After the copying completes, the re-copier component (118) may be activated one or more times to re-copy those objects that have been modified during copying. Since only a small fraction of the copied objects is likely to be modified during copying, re-copying them should be much faster than the original copying. If some objects are again written during the re-copying, those can be re-copied again, but the set of objects to re-copy should now be even smaller, as the previous re-copying was presumably faster than the original copying. This may be repeated a few times. Instead of re-copying entire objects it is sufficient to copy just the modified parts thereof.

The copy planner, copier, and re-copier advantageously run concurrently with mutators. While the copier (116) and re-copier (118) execute, a write tracker (120) is used for tracking which objects in the set being copied have been written into during copying, and those objects are scheduled for re-copy. The write tracker is advantageously implemented using a write barrier (most large-scale garbage collectors for general-purpose processors use a write barrier anyway). The write tracker may be at least partially part of the mutators (e.g., as part of a write barrier), or implemented in hardware as part of the processor(s).

The write barrier buffers are preferably read using soft synchronizations. In soft synchronization each mutator thread visits a special function and then continues without requiring all threads to stop simultaneously. For reading the buffers, each mutator thread moves its buffer(s) to, e.g., a list that is accessible to the re-copier, and starts using a new empty buffer. Alternatively, each mutator thread could iterate over its buffer(s) and add values to a re-copying queue (if not already there). However, such approaches are likely to require more synchronization than simply moving the old buffer(s) aside.

The objects to re-copy (119) is any suitable data structure or arrangement for representing which objects to re-copy. The data structure may be, for example, a hash table interpreted as a set, a bit map, or collectively some indicators in object headers.

The synchronizer component (122) implements synchronization between mutator threads (121). Preferably, it implements soft synchronization, which is used by the root extractor, liveness analyzer, write tracker/re-copier, and for remembered set updating. It may also implement stop-the-world synchronization, e.g., for switching to use new copies of modified objects.

The reference updater component (123) is used when switching to use new copies of modified objects. It updates any pointers from outside the copied objects to any of the copied objects to point to the new copy of the object. It is preferably activated only when all mutator threads are stopped.

The register, stack, and global variable updater component (124) is also used when switching to use new copies of modified objects. It changes any references to the copied objects in thread registers, stack frames, global variables, or other protected locations to refer to the corresponding new copies.

### Illustration of the Garbage Collection Cycle

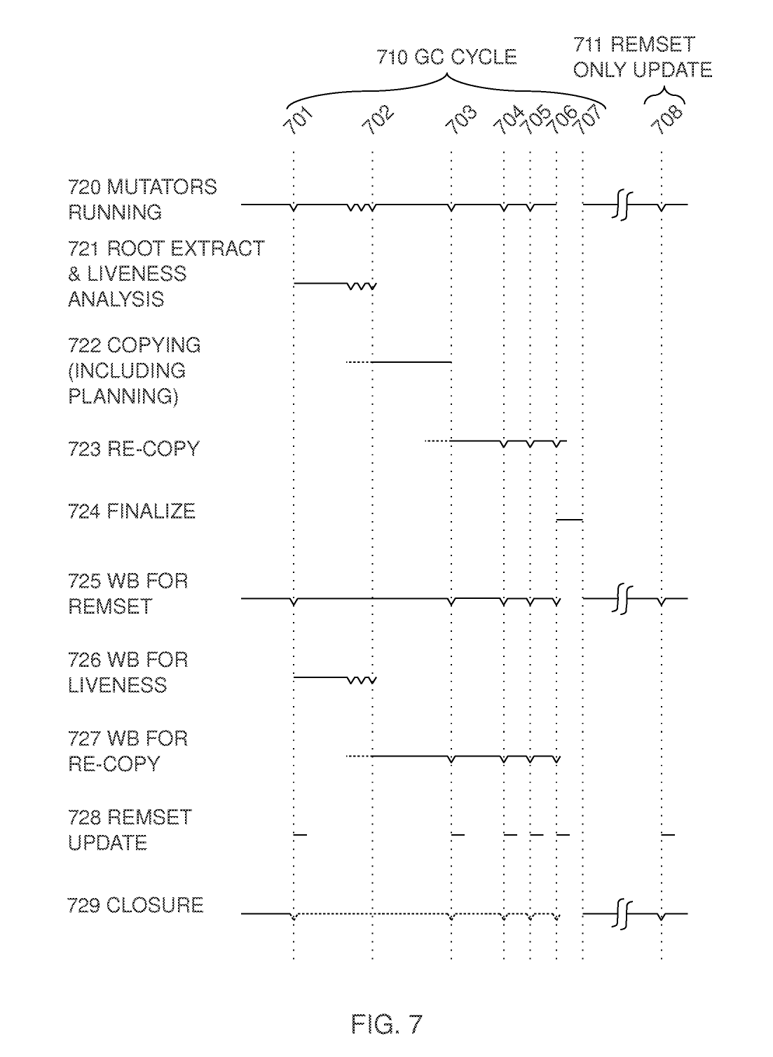

FIG. 7 illustrates the garbage collection cycle (710) in an embodiment of the invention. In some embodiments each garbage collection cycle might collect the entire heap (i.e., all objects). In other embodiments, only part of the heap might be collected in each garbage collection cycle.

A garbage collection cycle roughly corresponds to an evacuation pause; however, the garbage collector(s) described herein do not really pause the mutators for the duration of the collection cycle, except for a small fraction of it. During a garbage collection cycle, the garbage collector performs liveness detection for at least some subset of the objects in the heap, and may copy (move) some or all of them to new locations.

In FIG. 7, time flows from left to right, and (701) to (708) signify various points in time. The vertical axis contains various elements of the garbage collector, and indicates when they are active:
a solid line means the element is active or executing at that time
a notch indicates that something special happens with that element (e.g., soft synchronization/communication)
a dotted line means that the element might also be active there in some (more peripheral) embodiments
no line indicates that the element is not active at that time (though this is not intended to exclude the possibility that embodiments could be constructed where an element could be active at such time).

The elements covered are the following:
(720) illustrates one or more mutators (121) running (note that mutators in blocked calls or executing, e.g., C library functions such as signal processing code, are not considered as being running, and may continue to execute even when other mutators stop, as long as they stay in the blocking call)
(721) illustrates root extractor (112) and/or liveness analyzer (113) being active
(722) illustrates copy planner (114) and/or copier (116) being active
(723) illustrates re-copier (118) being active
(724) illustrates finalization (including re-copier (118) for final re-copy, reference updater (123), and register, stack, global variable updater (124)) being active
(725) illustrates when the write tracker (120) collects information about writes for remembered set updating (depending on how remembered sets are managed, this may mean collecting just written addresses, or also collecting their old values)
(726) illustrates when the write tracker (120) collects old values of written locations for use by the liveness analyzer (113) for implementing conservative liveness analysis
(727) illustrates when the write tracker (120) collects information about objects (or memory locations) that have been written into and may need to be re-copied
(728) illustrates remembered set updating being performed
(729) illustrates a global closure or global tracing operation being active for the purpose of ensuring that also garbage cycles spanning many regions or many nodes in a distributed system eventually get collected (in many embodiments, it would only run periodically, not at all times when it could).

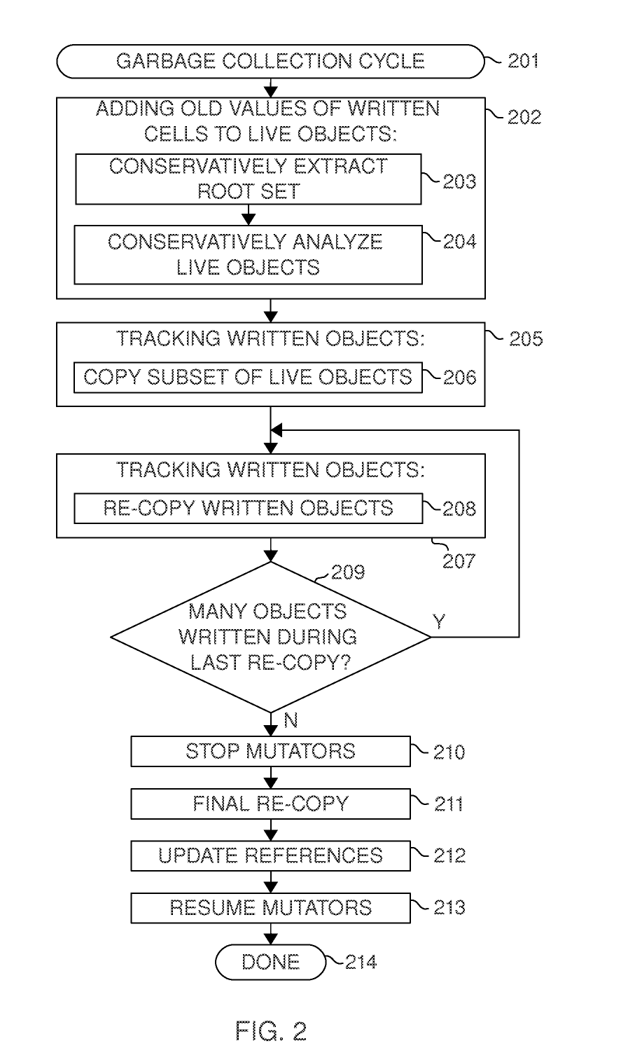

The illustrated time points are as follows (these are also illustrated in FIG. 2 from a different viewpoint).

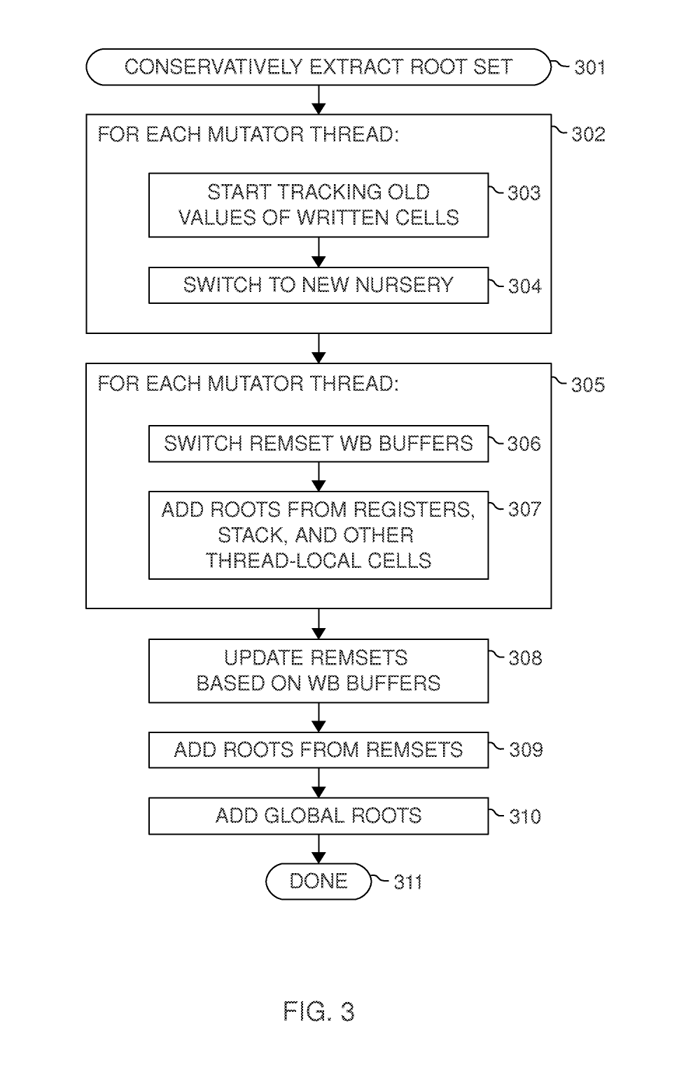

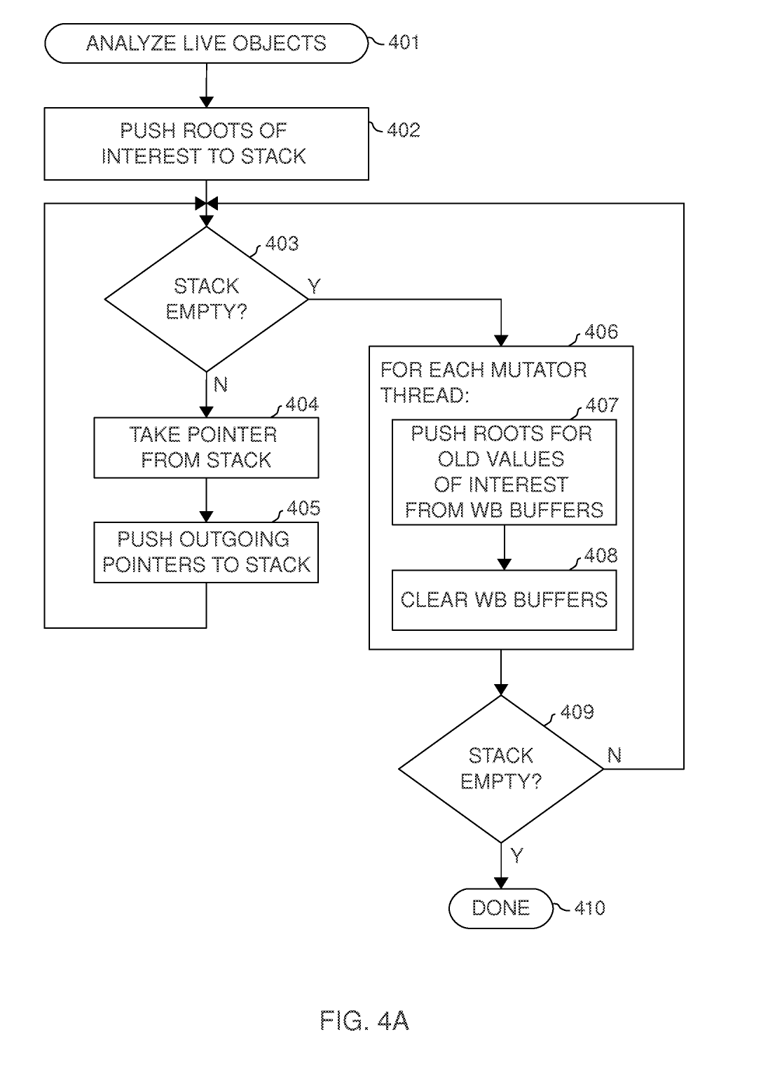

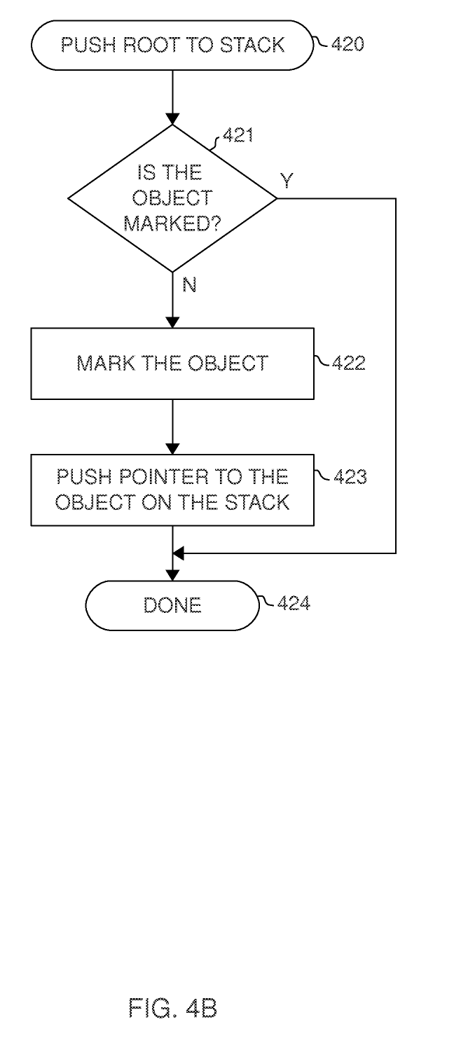

(701) illustrates the beginning of a garbage collection cycle. A garbage collection cycle may be triggered, for example, by the nursery area becoming relatively full, a write barrier buffer becoming too large or too full, global tracing or transitive closure terminating, or elapsed time since the previous garbage collector cycle. In an advantageous embodiment, at the start of the garbage collection cycle, all mutator threads perform soft synchronization (illustrated in more detail in FIG. 3), and root extraction and liveness analysis (illustrated in more detail in FIG. 4) begins. Remembered sets are also brought up to date.

During root extraction and liveness analysis mutators may continue to modify the heap. Therefore, the write barrier is used for obtaining the old values of memory locations written during root extraction and liveness analysis. Only old values that are pointers to cells need to be saved, and it is often not necessary to save pointers to popular objects or constant objects.

In some embodiments, root extraction may be performed as follows. First, a soft synchronization is used for causing each mutator to start collecting old values of written cells (including global variables and other global data). After all mutators have performed this step, a second soft synchronization is performed, extracting roots from registers, stack frames, and other thread-local data. Roots are also taken from values of global variables or other data (this may happen in parallel with mutators performing the second synchronization or after them).

In many embodiments, each garbage collection cycle only collects a part of the heap (e.g., some subset of regions in a region-based collector). The extracted roots should include all references to objects in the collected part of the heap (i.e., objects/regions of interest) from outside the collected part of the heap (usually found using remembered sets).

During liveness analysis, soft synchronization may be repeated several times to obtain the old values if thread-local write barrier buffers are used. Alternatively, old values could be pushed to a stack of the liveness analyzer in the write barrier, but then some kind of atomic instructions or other synchronization between threads would usually be needed.

When all roots have been processed, the stack of the liveness analyzer is empty, and no thread has saved any live values (in the memory regions of interest) that has not been visited earlier, liveness analysis is complete at (702).

The time point (702) illustrates when the system (conservatively) knows which objects (in the regions of interest) are live. In an advantageous embodiment, copy planning begins at that point, and copying begins after copy planning. In some embodiments, however, copy planning may not exist as a separate phase, and in some embodiments copying may start in parallel with liveness analysis.

It is no longer necessary to track old values of written cells in the write barrier for liveness analysis purposes after reaching time point (702). However, tracking for re-copying (i.e., tracking which memory locations or objects in the set of objects to be copied have been written into) should be enabled before copying starts. This tracking should include writes to non-pointer locations.

During copying (or re-copying), mutators do not see the new copies, and the old copies are not modified by the garbage collector (in ways visible to the mutators).

At (703), all objects to be copied have been copied once. In an advantageous embodiment, a soft synchronization is used for obtaining the sets of written memory addresses from thread-local write barrier buffers from mutators. The objects that have been written into are then re-copied (preferably to the same destination locations to which they were originally copied). Either the original objects may be re-copied entirely, or just the written memory locations may be re-copied (or the writes may be propagated to the new copies in some other manner—for example, the write barrier could make the write in both locations, but this would likely require atomic instructions for synchronization). It is also possible that sometimes no objects being copied have been written into during copying and thus no objects might need to be re-copied.

After the first re-copying, the soft synchronization and re-copying are preferably repeated until there are no objects to re-copy, or the set of objects or memory locations to re-copy is small (e.g., only a few or a few dozen objects). It is also possible to stop re-copying objects that have already been re-copied more than once, and leave them for a final re-copy performed when all mutators have been stopped. The time points (704) and (705) illustrate starting a second and a third re-copy phase, respectively.

At (706), all mutator threads are stopped for finalizing the garbage collection cycle. A final re-copy is performed (if any objects remain that have been written into since they were last copied), and all references to the old copies of copied objects are changed to point to the new copies (using, e.g., the reference updater (123) and register, stack, global variable updater (124)). Remembered sets may also be updated and write barrier buffers emptied.

At (707), finalization and the garbage collection cycle are complete, and mutator threads can continue execution. The write barrier continues to track writes for remembered set maintenance purposes (in those embodiments where it is needed).

Time point (708) illustrates the beginning of a stand-alone remembered set update (711). Such updates can be performed at any time by having mutators go through soft synchronization, and having a background thread (or in some embodiments, the mutators themselves) update remembered sets based on writes recorded in the write barrier buffers. It may be advantageous to perform such remembered set updates periodically between garbage collection cycles in order to keep the write barrier buffers reasonably small and to reduce delays in the actual garbage collection cycle. Such stand-alone updates are, however, entirely optional.

### Illustrative Process Steps for a Garbage Collection Cycle

FIG. 2 illustrates the garbage collection cycle from a method perspective in an advantageous embodiment. Beginning of the cycle is illustrated by (201). As the garbage collection begins, all or some subset of the heap is selected for garbage collection (this subset is referred to as the regions of interest or objects of interest).

The box (202) illustrates extracting the root set and analyzing liveness of objects in the subset while using the garbage collector to collect old values of written memory locations.

Step (203) illustrates conservative root set extraction by the root extractor (112). It is further illustrated in FIG. 3.

Step (204) illustrates conservative liveness analysis by the liveness analyzer (113). It is further illustrated in FIGS. 4A and 4B.

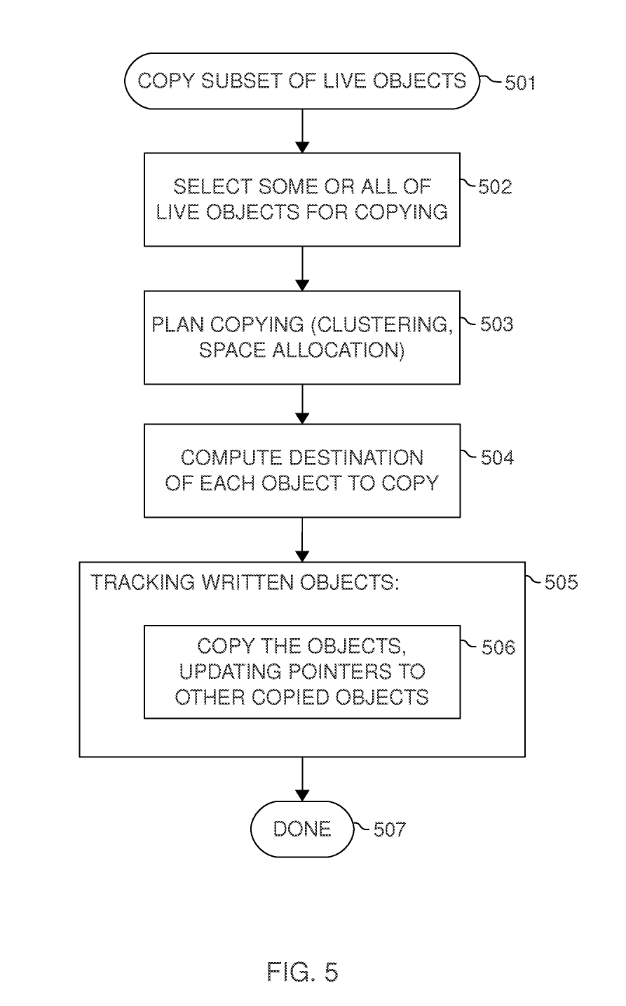

The box (205) illustrates copying objects while tracking which already copied objects are written into. The actual copying is illustrated by (206), and is further illustrated in FIG. 5.

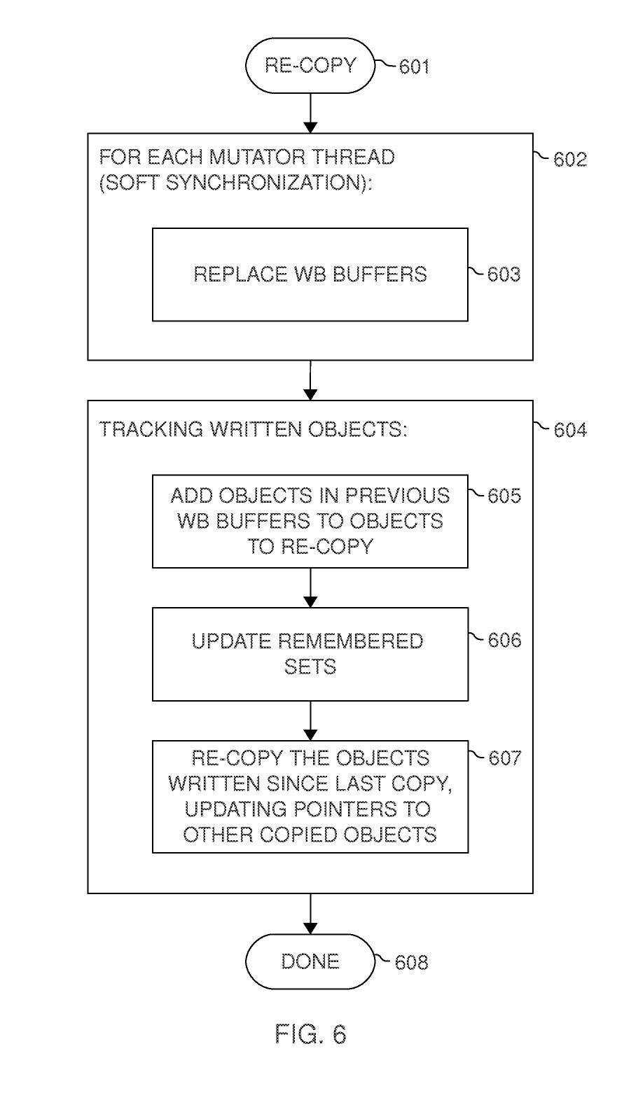

The box (207) illustrates re-copying objects that may have been written into since they were last copied, while tracking which already copied objects are written into. The actual re-copy operation is illustrated by (208), and is further illustrated in FIG. 6.

The test (209) illustrates checking whether another re-copying round should be performed. Typically no more re-copying should be done if any of the following is true:
the number and size of objects to re-copy is small (e.g., less than 20 objects and less than 10 kilobytes)
many of the remaining objects have already been copied more than N times (e.g., more than once) (such objects could also be postponed to last re-copy even if other objects continue to be re-copied)
re-copying has been done too many times (e.g., at least three times).

At (210) all mutators are stopped. It is known in the art how to achieve this, e.g., by setting a global variable that is checked by all mutators every time they enter a GC point, or by signalling an interrupt to all mutator threads. Well-known thread rendezvous methods are then used to wait until all threads have stopped (e.g., having them wait on a condition variable for the pause to end, and incrementing a count of stopped threads and signalling a second condition variable before stopping).

At (211) a final re-copy operation is performed similarly to the previous re-copies (see FIG. 6); however, since mutators are now stopped, there is no need to track writes using the write barrier.

At (212) all references to the old copies of the copied objects are replaced by references to their new copies. This includes, among other things, thread registers, stack slots, global variables, and/or any special data structures in the run-time system or virtual machine (for example, guard functions for objects needing explicit destructors). In embodiments where object references remain in write barrier buffers (e.g., for tracking changes for remembered set updating), they may need to be adjusted to refer to the new copies. Any remembered set data structures that contain references to the old objects are updated to refer to the new objects (depending on how the data structures are implemented, this may also involve additional changes, such as moving metadata from the object's old region to a new region, or re-indexing some metadata entry). This is discussed in more detail under Finalization below.

At (213) the execution of mutators is resumed, and the garbage collection cycle is complete at (214).

### Mutators and the Write Barrier

The term mutator is used in garbage collection terminology to refer to an application program (or thread) that may mutate the heap, i.e., modify the contents of objects in the heap, including links between them. A mutator is typically executed by a processor, and has an execution context used for tracking its state, called a thread. Associated with each thread is typically a set of registers (either actual processor registers or simulated registers, such as local variables on stack) and a stack for saving the execution context of earlier calls in a recursive program. Each thread may execute compiled machine instructions using a processor, or may interpret byte coded or other (typically) higher-level instructions using an interpreter, a just-in-time compiler, or a virtual machine (such as a Java virtual machine). Some threads may also be implemented fully or partly in hardware using a suitable state machine and memory for execution context and stack where applicable.

Each thread may read and modify its registers, stack, global variables, and memory locations on the heap (some embodiments may also have other thread-local or global locations).

When a thread reads a memory location on the heap (or a global variable), some systems employing garbage collectors use a read barrier to ensure consistency, particularly when objects are moved concurrently with mutator execution. Using a read barrier typically causes significant overhead to application execution, costing several percent of total execution time of an application (possibly more, possibly less, depending on the application). Various embodiments of the present invention can advantageously be used without a read barrier. Nevertheless, using a read barrier, as described in the book by Jones and Lins and in the incorporated references, is possible in some embodiments of the invention.

When a thread writes to a memory location, most large-scale garbage collectors use a write barrier to track which memory locations have been written. In some systems the write barrier tracks writes only coarsely, such as on a per-page granularity (typically 4096 bytes) using memory protection traps or per-card granularity (typically 512 bytes) using card marking. Some systems log all written addresses in log buffers (write barrier buffers), possibly with some filtering of duplicates. Some systems update hash table based remembered sets directly from the write barrier. Various combinations of the techniques can also be used, including using a combination of card marking and log buffers with a background thread for processing the buffers (e.g., Detlefs et al (2004)). Advantageous hash table based write barrier buffers have been described in the co-owned U.S. patent application Ser. No. 12/353,327 “Lock-free hash table based write barrier buffer for large memory multiprocessor garbage collectors” and Ser. No. 12/758,068 “Thread-local hash table based write barrier buffers”; these are hereby incorporated herein by reference. Thread-local hash table based write barrier buffers are particularly advantageous, as they can be maintained by mutator threads without using any atomic instructions in the write barrier. They can also be easily expanded when needed, without blocking any other mutators.

For remembered set updating it is generally sufficient to track writes to cells that can contain pointers, but for re-copying purposes the write barrier should track also writes to memory locations that cannot contain pointers (e.g., floating point fields in structures). One possibility is to have two different write barriers, one for pointer types, and another for non-pointer types. A compiler can be used to combine multiple invocations of the non-pointer write barrier for the same object into a single invocation. Also, it may be desirable to store the address of the written object, rather than the address of the written cell, with the write barrier used for re-copying. The re-copying write barrier would do nothing except when copying/re-copying is active.

When thread-local hash table based write barrier buffers are used, two separate write barrier buffer hash tables can be allocated for each thread. One hash table is used for collecting updates to the remembered sets. It is keyed by the address of the written cell, and stores the old value that the cell had when the write occurred as the value of the key.

The other hash table is used only during a garbage collection cycle, for two separate purposes (at different times): tracking which objects have been written into during copying, and tracking the old values of cells written during root extraction and liveness analysis. However, either or both of these functions may also be performed using the first hash table; it already contains the old values. If it is possible to find the object header quickly from an address within an object (many systems using card marking based write barriers already support this), then it can be used for finding the objects that have been written into during copying/re-copying (writes to non-pointer fields would also need to be added to the hash table during copying/re-copying, with, e.g., NULL pointer as their value). Old values could be obtained directly from the hash table. Whenever reading old values (in soft synchronization for each thread), the hash table would preferably be moved aside and a new hash table allocated; a background thread (such as the liveness analyzer) would then take the saved hash table, iterate over old values therein, pushing roots for old values of interest, and saving the buffers for use in the next remembered set update (or performing remembered set update immediately). Such a system could have a freelist for write barrier buffer hash tables and could clear the hash tables during iteration.

Various other alternatives also exist for tracking which objects have been written. For example, the distributed shared memory literature from the mid-1990's contains many articles describing methods of implementing fine-grained tracking and distribution of object changes, ranging from solutions similar to a write barrier to using memory protection traps to track the written locations to computing a “diff” (difference) between the original version of a page and the final version of the page. A person skilled in the art should be able to adapt these methods, and various other methods, for tracking the writes. Also, write barrier techniques need not necessarily use hash tables; for example, one could have a bitmap associated with each memory region that contains objects being copied, with one bit in the bit map for each address that can start an object (e.g., one bit per 16 bytes), and the write barrier could just set the bit corresponding to the written object to one (i.e., something like “bitmap[(addr−base)>>6] |=1LL<<((addr−base) & 63)”, possibly using an atomic instruction). A bit in the header of each object could also be used.

Mutators sometimes need to perform synchronization actions for garbage collection. A synchronization action may be triggered by setting a suitable flag and triggering a GC point, and performing the synchronization action when the mutator thread next enters a GC point. Alternatively, a signal or interrupt may be used to cause a mutator thread to perform synchronization. The implementation of GC points is described in O. Agesen: GC Points in a Threaded Environment, Technical report SMLI TR-98-70, Sun Microsystems Inc., 1998, which is hereby incorporated herein by reference. This paper also describes how to implement stop-the-world synchronization (i.e., stop all threads).

Threads that have informed the garbage collection system that they are in blocking calls are handled specially. Any available thread may be used for performing the synchronization operation (calling the relevant function) on their behalf. They should also be prevented from resuming after the blocking call before the synchronization operation for them is complete. They can be handled analogously for stop-the-world synchronization, as is known in the art (for example, the widely known, open source Jikes RVM implements similar operations using the setBlockedExecStatus( ) function).

When mutators synchronize, the synchronization operation may be a soft synchronization, where each mutator executes some action (typically by calling a specified action function) and then continues execution, without a requirement for all mutators to stop simultaneously.

In most embodiments, there is a special memory area called the nursery, or young object area, from which mutator threads allocate objects. Advantageously, TLABs (Thread-Local Allocation Buffers) are used for speeding up allocations by mutator threads, as is known in the art.

In some embodiments there may be more than one nursery area. Advantageously, when a mutator thread performs its first synchronization for a garbage collection cycle at (701), it switches to a new nursery. The write barrier will then be made to track writes to the old nursery, but only in limited ways to the new nursery. This approach reduces write barrier overhead during the garbage collection cycle, because most writes by mutator threads will be to newly created objects and many values will also point to very new objects, which will both be in the new nursery. If all live objects from the old nursery are copied (i.e., moved away) during the garbage collection cycle, then the old nursery can be freed at the end of the garbage collection cycle.

Note that even though the values written to the new nursery may refer to objects in the old nursery or old regions, such values must have been reachable at the time the mutator thread switched nurseries. Thus, they will be found by tracing from the roots or from the old values of any written cells caught by the write barrier. However, references from objects in the new nursery to copied objects will need to be updated during finalization.

A garbage collection cycle should be started early enough so that there is sufficient space available for the new nursery to grow while the garbage collection cycle is active.

There may also be embodiments that keep several nurseries, and only copy objects from the old nurseries after several garbage collection cycles (for example, to accumulate sufficiently many objects to fill a fixed-size memory region or to be able to cluster them properly, or to allow more young objects to die before needlessly copying them). At each garbage collection cycle, uncopied garbage collected nurseries will need to be traced together with the most recent old nursery, or alternatively the garbage collection cycle may construct remembered set data structures (in any suitable form known in the art) for the old nursery, so that it need not be re-traced during later garbage collection cycles.

As the write barrier records written memory addresses (or object pointers), and possibly the old values of written memory locations, it may perform filtering on the writes as is known in the art (i.e., it will not record all writes). Frequently used filtering criteria include the following:
writes to (new) nursery usually need not be recorded (however, see below under the “Remembered set update” section)
writes whose values are non-pointers, constants, or popular objects need not be saved in many embodiments
writes whose values are younger than the written object often need not be stored (generational collectors, train collectors).

The write barrier is usually designed to minimize the number of instructions performed in the fast path (the most typical case). Typically write barrier instructions are ordered such that the average number of instructions is minimized, and the application's memory map is designed in such a way that as many tests as possible can be performed simultaneously or with as simple instructions as possible, as is known in the art.

Frequently, testing whether the address being written into is something that needs to be saved is done by a comparison similar to

if (((unsigned long)addr − (unsigned long)old_heap_start) <

old_heap_size)

perform_other_tests_and_save_if_appropriate( );

If more than one nursery is used, implementing filtering using address comparisons may not be sufficient. In such embodiments (assuming a memory organization based on fixed regions stored contiguously in memory at addresses that are multiples of their size), using a bitmap to track which regions are to be treated old regions may be useful. In such embodiments, the following code snippet illustrates one possible way of implementing the filtering (this is for 64-bit machines; the constants on the second line will be 5 and 31 for 32-bit machines):

int regidx = (addr − region_base) >> log2_of_region_size;
if (old_region_bitmap[regidx >> 6] & (1L << (regidx & 63)))

perform_other_tests_and_save_if_appropriate( );

In such embodiments, the bitmap could be updated before the first synchronization (701) and possibly (depending on the memory consistency model of the underlying platform) using a memory barrier instruction during the synchronization operation to ensure that all threads have started using the updated bitmap (this possibly results in some extra writes being recorded to the write barrier buffers, but they can be filtered when processing the buffers), or it could be made thread-local, and updated during the first synchronization.

A similar bitmap could also be used for quickly identifying which writes are to regions containing objects being copied. When recording written objects for re-copying, such a bitmap could be used to avoid recording written objects that are not in the area being copied.

In some embodiments the write barrier might also be implemented directly in hardware (possibly as an extension to the instruction set of the processor(s)). Several hardware-based write barrier implementations have been described in the garbage collection literature over the past three decades.

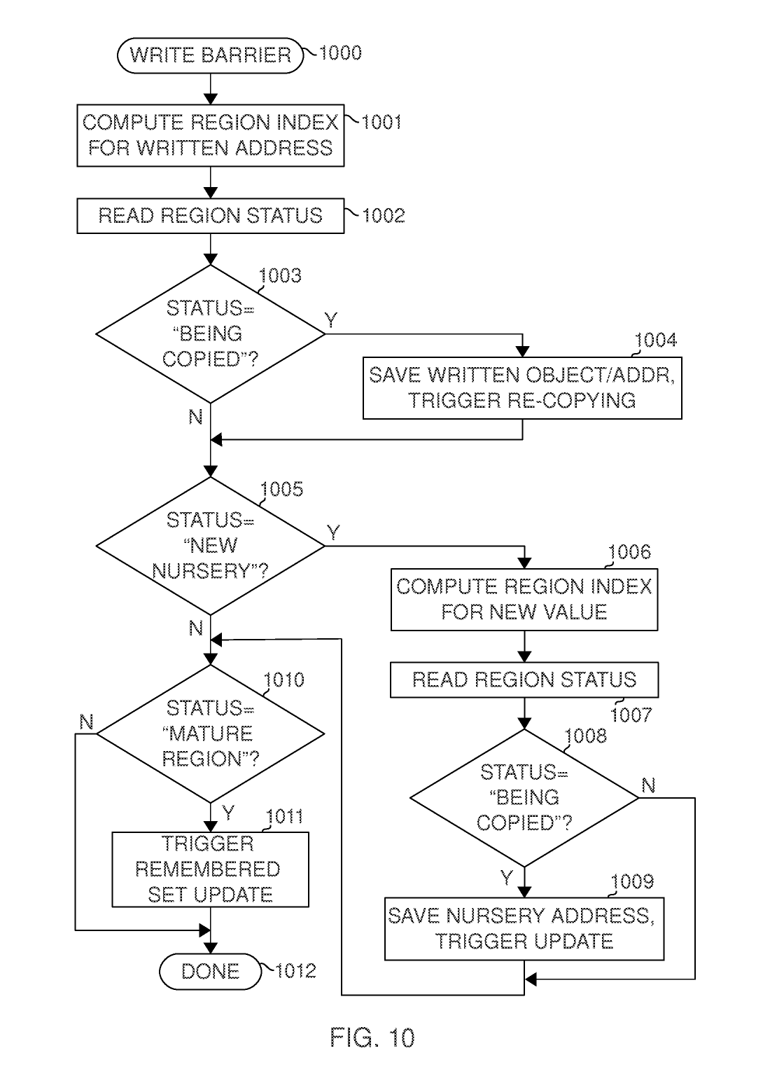

FIG. 10 further illustrates the implementation of a write barrier (1000) in an embodiment. (1001) illustrates computing a region index from a written address. In one embodiment, the region address is computed as “region index=(addr−first region start addr)>>log 2(region_size)”. This can be performed with two fast instructions on most modern processors and does not require memory accesses. (1002) reads a region status value from a region status array. In one embodiment, it simply indexes an array, e.g., “status=region_status_array[region_index]”. In another embodiment it could use a chunked array described in the co-owned U.S. patent application Ser. No. 12/775,640. (1003) checks if the status indicates that the region is currently being copied (i.e., is a region of interest). If so, (1004) saves the written address, triggering re-copying of the written object or relevant parts thereof. It may also save the new written value and/or the old value. Only the most recent value needs to be kept; the saving could use, e.g., some kind of linear buffer or chain of buffers, or one or more hash tables. Use of thread-local data structures is advantageous in order to avoid locking and atomic instructions. (1005) checks whether the status indicates that the write is to the (new) nursery during copying (generally there is no need to track nursery writes except during a garbage collection cycle). If so, (1006) and (1007) determine the status of the region containing the new value being written (handling of non-pointer values is not shown but is straightforward: (1008) and (1009) can be skipped for such values). (1008) checks if the written value points to a region of interest, and if so, (1009) saves the written address, triggering the pointer written to the nursery to be later updated to point to the new copy of the respective object (assuming it is not overwritten by another value before the update). It is sufficient to save each nursery address only once. Suitable data structures for saving the address include linear buffers, hash tables, bit vectors, etc. Use of thread-local data structures is advantageous in order to avoid locking and atomic instructions. (1010) checks if the write is to a mature region, and if so, (1011) triggers remembered set updating for the written location (e.g., by saving the written address in a suitable data structure). Depending on the old and new values of the written memory location, remembered set updating may add, remove, or modify a remembered set entry associated with the location. (1012) completes the write barrier operation. Causing a liveness analyzer or tracer to visit an object that was the old value of a written memory location is commonly also performed in order to implement snapshot-at-the-beginning (SATB) marking.

A possible alternative view of the region status array and the write barrier is that the region status array contains for each region one or more (highly specialized) instructions that the write barrier executes (either directly in hardware, or by software emulation), acting as a highly specialized processor for such instruction(s). The region status may be structured, e.g., as a single numeric code or as a value containing several fields (possibly just one bit wide) indicating which of the different actions the write barrier should perform and how. If the write barrier needs to perform several actions for a single write, it may also perform them in parallel. Also, in some embodiments the write barrier may also just trigger (e.g., by queueing a request or adding information to a data structure) an action, and the action may (at least partially) take place after the write barrier has allowed the execution of the mutator to resume. For example, if a write is to be propagated to another node in a distributed system, several writes to be propagated could be combined and only sent to other nodes when a mutex (mutual exclusion lock) is taken or released, or when a transaction (as in distributed transactional memory) commits.

### Root Extraction

FIG. 3 illustrates conservative root extraction in detail. Note, however, that additional “roots” (i.e., pointers to objects of interest, typically from outside the objects of interest themselves) may be added still during liveness analysis from old values of memory locations that are written during root extraction and liveness analysis.

It may be desirable to select the objects of interest (or regions of interest) at the beginning of the garbage collection cycle. Since the garbage collector runs in parallel with mutators, the size of the set is not so critical as in, e.g., the Garbage-First Collector (Detlefs et al (2004)), and there is no need to expand the set dynamically during the garbage collection cycle (though conceivably in some embodiments it could be dynamically expanded). A low-priority background thread could even be used to compute the optimum set between garbage collection cycles when extra processing cores are available (and/or the computation could be completed during the garbage collection cycle if it is not ready by then). Ideally, a priority queue will be used for selecting which regions/partitions to collect (similarly to, e.g., Detlefs et al (2004) and J. Matthews et al: Improving the Performance of Log-Structured File Systems with Adaptive Methods, SOSP'97, pp. 238-251, ACM, 1997).

Root extraction begins at (301). This roughly corresponds to entering time point (701) (i.e., garbage collection cycle is beginning).

The box (302) illustrates an initial soft synchronization that is used for enabling the tracking of old values of written cells (303) and for switching mutators to allocate new objects in a new nursery (304). Thus, after this box, no mutator will be allocating new objects from the old nursery. (It would also be possible to continue to use the same nursery for new objects, particularly if a freelist is used for allocation and if objects are marked as “new” by, e.g., using a flag in their header to indicate in/after which GC cycle they were created.)

Old values typically need to be tracked for writes to the heap (except the new nursery, mostly) and to global roots (global variables and other global data structures, such as new/changed guard functions that serve as object destructors).

The box (305) illustrates a second soft synchronization, which is used for reading the write barrier buffers used for tracking writes for the purpose of updating remembered set buffers (306). Advantageously, these buffers are linked to the mutator thread using a pointer, and this just saves the pointer in a suitable list (where the buffers from all mutators are collected, using, e.g., a mutex or atomic instructions to protect concurrent access to the list as is known in the art), and a new empty write barrier buffer is allocated for the thread (the allocation could also happen later, when it is actually needed). In some embodiments the buffers might already be read at (302).

At (307), all thread-local roots are extracted and added to the system's bookkeeping. This typically includes extracting roots from registers, stack slots (including local variables), and any other thread-local cells (including thread-local storage, if any). In some embodiments this step may store the potential roots in a thread-local data structure (e.g., a hash table used for eliminating duplicates), and then adds the whole data structure at once to a list that is processed after the soft synchronization (e.g., at (308)). It is well known in the art how to enumerate roots, including the use of bitmaps for tracking which local variables are live at each GC point, compressed representations of such liveness information, various optimizations for stack traversal, etc.

At (308), remembered sets are updated based on data in the buffers saved at (306) (although the update could also have been performed already at (306), doing it there would have meant a longer pause for the mutator thread). The remembered set update may be performed using a single thread, or it may utilize multiple threads with suitable synchronization (e.g., using locking or dividing the work so that each thread works on a non-conflicting part of the remembered sets).

At (309), roots are added from the remembered sets. This includes inter-generation pointers in generational collectors and inter-area or inter-region pointers in area/region-based collectors (see Bishop (1977) and Detlefs et al (2004)).

At (310), roots are added from global roots. (Any old values of global roots modified during root extraction will be added later when the write barrier buffers are processed.)

Root extraction is complete at (311), except for roots added based on old values of written objects.

The method of extracting roots described herein resembles the use of sliding views for root extraction; however, sliding views are only one possible approach for root extraction, and almost any known root extraction method may be adapted for use here. The well-known sliding views method has been described in detail, e.g., in Y. Levanoni and E. Petrank: A Scalable Reference Counting Garbage Collector, Technical Report CS0967, Technion, Israel, 1999. It has been applied to copying collectors, e.g., in Pizlo et al (2007).

Other possible ways of performing root extraction include stopping all mutator threads simultaneously and extracting their and global roots while all mutators are stopped. Such stop-the-world extraction has been widely used in many copying garbage collectors and should be easily implementable to one skilled in the art.

Root extraction is typically implemented by the root extractor (112).

### Liveness Analysis

Liveness analysis can run concurrently with mutators, and therefore needs to take into account possible modifications to the object graph that may occur during its operation. The write barrier is used for collecting old values of any objects written during liveness analysis, and these are taken into account as additional potential roots during the liveness analysis.

Depending on the embodiment, liveness analysis may be performed for the whole heap (including the (old) nursery), or may only be performed for a subset of the heap (the objects of interest).

Liveness analysis is commonly performed by tracing the object graph of an application, and marking those objects that have been visited. The marking can be implemented in any of a number of ways, including but not limited to setting a forwarding pointer in object header, toggling a bit in the object header, setting a bit in a separate bitmap used for marking objects, or otherwise setting an indicator corresponding to each object. Various ways of implementing liveness analysis are described in the book by Jones and Lins (1996).

When mutators run concurrently with the liveness analysis, the liveness analysis should take into account modifications to the object graph that may occur during the liveness analysis (note, however, that some functional programming languages forbid such modifications). Such modifications can be advantageously taken into account by tracking the old values of written memory locations in the write barrier, and periodically (at least when out of work) taking into account any old values recorded by the write barrier(s).

Since mutators may be executing concurrently with the liveness analyzer, the liveness analysis is advantageously implemented in a manner that does not modify (clobber) the live objects in ways that are visible to the mutators.

FIG. 4A illustrates conservative liveness analysis for use in connection with the conservative root extraction method. The liveness analyzer is described as a single-threaded process; however, in a practical system it could be implemented using more than one thread, e.g., as described in the co-owned U.S. patent application Ser. No. 12/388,543 “Parallel garbage collection and serialization without per-object synchronization”, which is hereby incorporated herein by reference.

Liveness analysis starts at (401). At (402), any roots discovered so far are pushed onto a stack (alternatively, the root extractor could have directly pushed them on the stack). As an alternative to a stack, a work queue data structure could be used (many work queue implementations supporting varying levels of concurrent access have been described in the literature and are available to one skilled in the art). Each object is marked as it is pushed to the stack.

Steps (403) to (405) implement a traditional tracing or “mark” operation. (403) checks if there are more objects to consider; (404) takes a pointer to an object from the stack; and (405) iterates over all pointers out from the object and pushes them on the stack (as they are pushed, it is checked whether they have already been marked, and they are only pushed if they are not marked; each object is marked as it is pushed).

The box (406) illustrates taking recorded old values from the write barrier buffers of mutators. This can be performed using a soft synchronization that pushes roots for any old values (in the area/objects of interest) to the stack (407), and clearing/replacing the write barrier buffer(s) used for recording the old values (408).

Box (406) could alternatively be implemented so that each mutator thread just saves its write barrier buffers used for recording old values in a list and switches to a new buffer; when this has been done for all mutators, the liveness analyzer could then process the buffers in parallel with mutator execution, marking and pushing any new objects.

At (409), it is tested if the stack is still empty after taking any written objects from mutators. If the stack is still empty, then mutators cannot have any references to any objects (of interest) that would not have been found by the liveness analyzer, and liveness analysis is complete at (410).

FIG. 4B illustrates pushing a root or object (pointer) to the stack. The operation starts at (420). (421) checks if the object has already been marked (i.e., already visited during this garbage collection cycle). If it has not already been marked, (422) marks the object and (423) pushes the root/object (pointer) to the stack. The stack may be implemented, e.g., as an array with a stack pointer, as an expandable array, as a list of blocks, or as a linked list. (424) illustrates the end of the operation.

Not shown in the figure is that pointers pointing to outside the regions of interest need not be marked or pushed. The test (421) could be augmented to also check if the pointer is to within the region/objects of interest, and skip marking and pushing if it is not.

Liveness analysis is typically performed by the liveness analyzer (113), whose functioning is thus illustrated by FIGS. 4A and 4B.

The liveness analyzer may just record which objects are live using a per-object indicator (e.g., a bit). It may also construct a suitable data structure of objects for use in the copy planning stage (or such a data structure may be constructed by a separate step considered part of the copy planning stage). Such a data structure could, for example, be a set (e.g., array or hash table) containing pointers to live objects of interest. Alternatively, it could be a set of roots of trees for tree-like subgraphs of the graph of objects of interest, with the size of the subtree stored for each root (note that the word root is used here in the meaning that it has in connection with tree data structures, rather than its garbage collection meaning which is more commonly used in this specification).

It would be possible to use either a snapshot-at-the-beginning or an incremental-update approach for conservatively extracting the roots and conservatively performing liveness analysis. The approach above is based on the snapshot-at-the-beginning approach. Additional information can be found in P. Wilson: Uniprocessor Garbage Collection Techniques, IWMM'92, pp. 1-42, Springer, 1992, which is hereby incorporated herein by reference.

In some embodiments the set of objects of interest (or memory regions of interest) may be enlarged during liveness analysis, for example, to include some existing regions densely connected to objects in the nursery, so that they will be re-clustered together in the copy planning stage. Such enlargement of the set of objects of interest may require tracking roots in the root extraction stage for all memory areas that may be included in the (enlarged) set of objects of interest, or re-extracting them for the enlargement.

### Copy Planning & Copying

The copy planning stage refers to deciding which objects to copy.

FIG. 5 illustrates copy planning and copying in an embodiment of the invention.

At the beginning of the operation (501), liveness analysis (and root extraction) is complete. It is no longer necessary to track old values of written memory locations in mutators (unless such tracking is needed for remembered set maintenance).

At (502), some or all of the (conservatively) live objects are selected for copying (they are also called herein the objects to copy or the copied objects). It is expected that in most embodiments all of the live objects of interest will be copied. However, in some embodiments it is possible to decide that some of the live objects will not be copied in the current garbage collection cycle (or even that no objects will be copied in the current garbage collection cycle). It is also possible to treat tree-like subgraphs of objects similarly to single objects for copy planning purposes, and make the copying decisions for a tree-like subgraph (or other suitable subgraph) at a time.

When it is known which objects to copy (and their total size), the system may allocate enough memory regions for them to ensure that copying cannot run out of space even if memory is tight and mutators are simultaneously allocating memory. If the regions cannot be allocated, the garbage collector can decide not to copy the objects in this cycle, and may signal mutators that memory is low. If mutators subsequently run out of memory, they may stop to wait until garbage collection is complete (at which time more memory is usually available), or they may raise an exception that the application program may use to reduce size of some data structures (or in the extreme, terminate the application). Some run-time environments may also have data structures, such as caches, that can be automatically and dynamically re-sized, and running low on memory could trigger reducing the size of such data structures. Some embodiments might delete replicas of data also stored on other nodes in a distributed system or on disk, or might trigger flushing changes in modified regions to disk or their home nodes.

The step (503) illustrates copy planning and space allocation. Many systems have no separate copy planning step, and the space allocation may also be performed while copying (or during liveness analysis). A separate copy planning step may, however, be useful in systems with very large memories, in distributed systems, or in persistent object systems. In such systems the object graph is very large, and clustering (memory locality) issues become important. The better objects referencing each other are clustered together, the smaller the remembered sets in the system will be. Also, if long-lived objects are clustered into one region, and short-lived ones into another, overall garbage collection efficiency will be improved, because the region containing long-lived objects will not need to be garbage collected again for a long time. The copy planning stage may also decide that some objects have existed for a long time and are referenced from many places, and therefore should be made popular objects (for which remembered sets are typically not maintained).

The copy planning step basically takes as input the set of live objects of interest (or set of groups, such as tree-like subgraphs, of such objects), and assigns a cluster tag, region identifier, or destination address for each object (or group of objects). When it directly assigns a destination address, it is performing allocation directly during the copy planning step. When it only assigns a cluster tag or region identifier, allocating space may be performed later, e.g., as the objects are copied. Grouped space allocation may be advantageously used for allocating space for an entire cluster of objects at a time (see U.S. patent application Ser. No. 12/436,821 “Grouped space allocation for copied objects”); however, other allocation methods known in the art may also be used. Various clustering criteria and methods are discussed in U.S. patent application Ser. No. 12/464,231 “Clustering related objects during garbage collection”.

The input data structures for copy planning may be constructed already during liveness analysis, or they may be constructed as a separate step before or during copy planning.

A trivial copy planner simply divides the objects into regions. It may iterate over all objects to be copied in some arbitrary order, and as long as space remains in the current region, assign the object to that region. When no more space remains, it allocates a new region and assigns the object to that region.

A more sophisticated copy planner may use a graph partitioning algorithm, such as the one described in C. M. Fiduccia and R. M. Mattheyses: A Linear-Time Heuristic for Improving Network Partitions, 19th Design Automation Conference, pp. 175-181, IEEE, 1982. The graph partitioning algorithm is designed to approximate dividing the set of objects into partitions such that as few connections (pointers) as possible cross partition boundary. An arbitrary set of objects may be divided into regions by recursively dividing the set of objects to copy in half, until the total size of objects in each partition is smaller than the size of a region.

The graph partitioning approach may also be used for the construction of distinguished subgraphs (see U.S. patent application Ser. No. 12/489,617 “Copying entire subgraphs of objects without traversing individual objects”), dividing until the size of each partition is smaller than the maximum size of a distinguished subgraph. It is also possible to assign different weights to different connections, and to add connections to outside objects (e.g., clusters) to further influence the partitioning while still using the same partitioning algorithm.

The term “cell” is used in this document mostly in its conventional garbage collection or Lisp meaning (basically just meaning a memory location, usually in the heap; however, there is the added connotation that cells can contain pointers and/or tagged data in systems that use tag bits). In contrast, the paper by Fiduccia et al uses the term “cell” to refer to a vertex of a graph, or the smallest unit that can be moved from one partition to another (roughly corresponding to a component in CAD layout problems and an object or group of objects herein).

The step (504) illustrates computing a destination address for each object to copy, and setting up the copy locator (117) data structure. The copy locator provides an efficient means for finding the destination address for each object to be copied (i.e., the address at which its new copy will reside). A very simple implementation for the copy locator is a forwarding pointer in object headers.

The box (505) illustrates actions that are to be performed while tracking which objects are written into.

Step (506) illustrates copying the selected objects, and updating pointers to other copied objects. More than one thread may be used for the copying. If destination addresses have already been allocated before copying, it is easy to parallelize the copying (there is basically no synchronization needed between the threads; just divide the work into suitable chunks, and each thread looks up the destination address for the object, copies it, and updates pointers in the object using information from the copy locator, which is only read at this stage and thus needs no synchronization operations).

(507) illustrates the end of the operation.

However, copying may also be performed in other ways, including in conjunction with liveness analysis. If copy planning is done for groups of objects (e.g., tree-like subgraphs), then such groups might be traced at this stage (similar to multiobject construction in U.S. Ser. No. 12/147,419).

On NUMA (Non-Uniform Memory Access) machines it may be advantageous to allocate each region from a particular NUMA node, and use a thread executing on that NUMA node for copying objects into that region, thereby reducing load on the interconnection fabric between processors.

In some embodiments mutators may store extra information in conjunction with some or all allocated objects. For example, mutators could store the address in the program code where an object was allocated (or two or more call addresses from topmost stack frames). In many applications there is a high correlation in life times between objects allocated in the same function (or same call path to a function), and such information would allow the copy planner to utilize this information when clustering the objects. One way to use this information would be to have “cells” (that are not moved during clustering) represent call sites with significant predictive behavior, and have each object connected to the call site where it was allocated, with the weight of the link related to the predictive power of the call site. The partitioning algorithm would then automatically take the call site into account as one criteria for clustering, among the others.

Copy planning is typically performed by the copy planner (114), producing a copy plan (115). The copying is then performed, based on the copy plan, by the copier (116), which produces a copy locator (117), which in turn will be used by the re-copier (118). However, it is possible to practically eliminate the copy planner, integrating copying decisions into the liveness analyzer (using a trivial policy, such as “copy everything to the next available free memory address”). Copying could be performed fully or partially already during liveness analysis. Some embodiments might have no explicit copy plan (especially if copying is performed already during liveness analysis).

### Re-Copying

Since there is no synchronization between copying and mutators, each new copy may or may not represent the current version of the corresponding original object in the heap after copying. However, only a small fraction of objects is modified in any short time span, and thus only a small fraction of the copied objects is likely to be out of date. The idea of tracking which objects have been written into during copying is that we can then re-copy those objects (or possibly just the modified memory locations in them), bringing the copy up to date. However, additional modifications may occur during the re-copy. Since only a small fraction of copied objects normally need re-copying (the objects to re-copy (119)), the re-copy operation is normally much faster than the original copying, and therefore fewer objects are likely to have been modified during the re-copy than the original copy. Thus, repeating the re-copy two or a few times, the number of remaining objects to be re-copied is likely to be very small. A final re-copy can be done during the finalization stage when all mutators are stopped; this final re-copy is likely to be very small and fast.

FIG. 6 illustrates re-copying. The re-copying operation starts at (601), usually after copying is complete (though it is possible to start re-copying even before all objects have been copied). Re-copying is normally performed by the re-copier (118).

The box (602) illustrates actions performed by each mutator thread, preferably using a soft synchronization (i.e., not all mutators need to perform them at the same time). Basically, in this box each mutator thread replaces its write barrier buffers (603) by saving its current buffers (both those used for tracking writes for remembered set updates and those used for tracking which objects have been modified during copying) in a list (perhaps two separate lists), starts using new buffers, and continues. The write barrier continues to track writes, both for remembered set updating purposes and for tracking which objects (in the set being copied) are written into. It would also be possible to process the buffers here, but to keep mutator pauses short they are advantageously performed in (604).

The box (604) illustrates that actions therein are performed while tracking which objects are written into (and in most embodiments, also tracking writes for remembered set updating purposes).

At (605), objects in the saved write barrier buffers used for tracking which copied objects have been written are added to a set of objects to re-copy.

At (606), remembered sets are updated based on the saved write barrier buffers used for tracking writes for remembered set updating purposes. It would not be necessary to do this here, and such updating could be postponed until later (e.g., to the finalization stage). However, doing it here shortens the finalization pause. The remembered set updating may also be done in parallel with (607).

At (607), those objects that have been modified since the last copying are re-copied, and any pointers in them referring to other copied objects are updated to refer to the new copies of such objects. Alternatively, this could also be implemented by only copying those memory addresses that have been written.

(608) illustrates the end of the operation.

In some embodiments the re-copying may be augmented by detecting frequently updated objects, and postponing re-copying them to the finalization stage. For example, a flag (e.g., in the object header or in a separate bitmap) could be used for indicating that the object has already been re-copied once, and if it would need to be re-copied again, its second re-copy could be postponed to the finalization stage.

Tracking the number of copies could be done, e.g., by reserving space for a counter in the object header (one or two bits would probably suffice) or by using a hash table to track which objects have already been re-copied (adding each object to the hash table when it is re-copied, and possibly keeping a count as the value corresponding to the object in the hash table). Any count in the object header could share the same word with a forwarding pointer and a liveness indicator (the bits could be, e.g., stored in the lowermost bits of the forwarding pointer if objects are guaranteed to be aligned at, e.g., 8 or 16 byte boundaries; these bits would be masked away when the forwarding pointer is used).

### Finalization

The finalization phase is used for atomically (with respect to the mutators) switching to use the new copies of the copied objects. If a read barrier was used, there would be no need to make this change atomic, as then all reads and writes occurring in this stage could be re-directed to use the new copies, and updating thread state and global variables could be performed using soft synchronization and concurrently with mutators. Since a read barrier incurs a significant overhead on program execution time (and power consumption in mobile devices), it is preferable to avoid the use of a read barrier. Most applications can tolerate a short pause in mutator execution, and even stopping all mutators (a stop-the-world pause) is quite fast on modern computers (probably on the order of tens of microseconds—note that threads already in blocking calls do not need to be waited for).

It is, however, important to minimize the duration of the stop-the-world pause (i.e., the time when mutators are stopped). As much work as possible should be performed outside the pause and only a minimum amount during the pause. It may also be desirable to do as much precomputing as possible before the pause, such as dividing work into chunks that can be performed by separate threads—for example, remembered sets could be traversed and addresses to be updated divided into chunks based on their locality or NUMA node, leaving only a small remainder to be processed ad-hoc during the pause.

Step (210) in FIG. 2 illustrates stopping all mutators. Mutators in blocking calls, however, can continue to execute those blocking calls as long as they are prevented from returning to garbage-collected code before the pause is over. Blocking calls may also be lengthy computations, such as image processing actions or FFT (Fast Fourier Transform), that are often implemented as C language or assembly language libraries. Such operations may continue to execute in parallel with the stop-the-world pause if they are treated as blocking calls. (Blocking calls are typically not allowed to access any objects that might be moved, and are usually not allowed to mutate the object graph in any way.)

Step (211) illustrates a final re-copy, ensuring that all new copies of copied objects are up-to-date. Since mutators are stopped, it is not possible that there would be any updates to such objects during this final re-copy. Also, step (603) may be implemented by just taking the buffers from the mutators, since they are already stopped, and no writes to the copied objects can occur in (604) because the mutators are stopped. Step (606) illustrates a final update of the remembered sets.

Step (212) illustrates updating references to the copied objects. Any pointers (accessible to mutators) that might refer to the copied objects are changed to refer to the corresponding new copy (e.g., looking up the location of the new copy from the copy locator (117)).

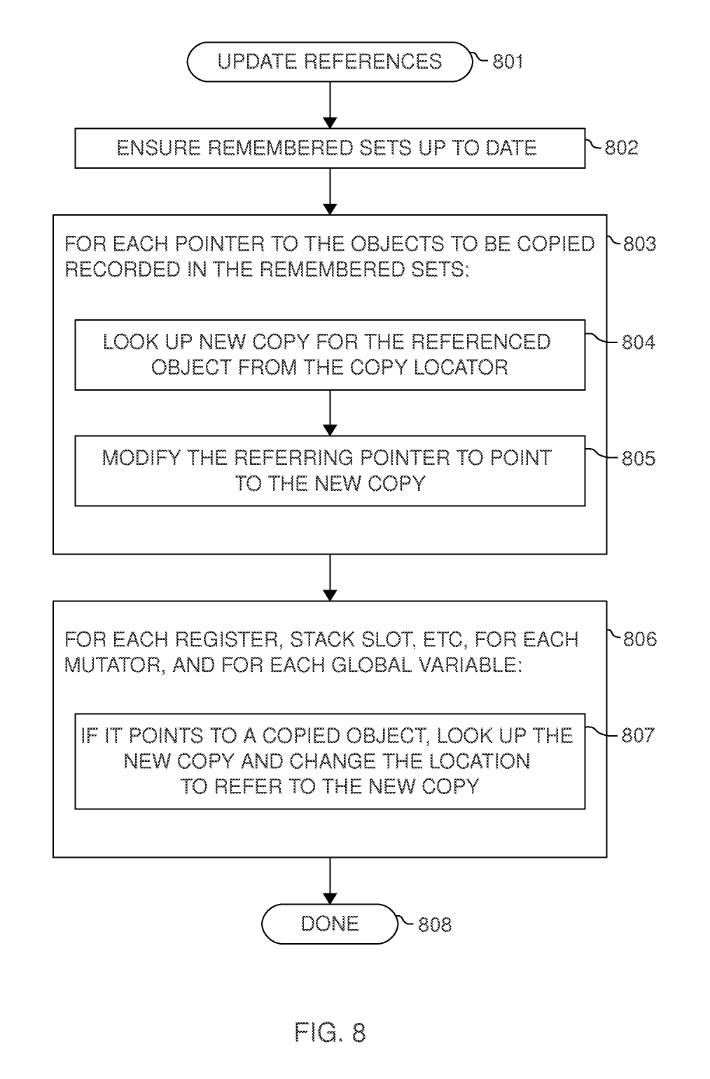

FIG. 8 illustrates one way of updating references (801) to the copied objects. (802) illustrates ensuring that remembered sets are up to date (this was actually done during the final re-copy above in the described embodiment(s)). The box (803) illustrates updating pointers identified in the remembered sets that refer to any of the copied objects. For each referring pointer (whose address is identified in the remembered set, and whose value is read from the memory location at the address), the new copy of the referenced object is looked up from the copy locator (804), and the memory location containing the referring pointer is modified to point to the new copy (805). Updating the references is performed by the reference updater (123).

Essentially the same is done for each thread-local slot of each mutator thread and for each global variable (or other global slot, including guard functions of objects, timeout callback functions, etc.) containing a pointer to one of the copied objects in (806); if the value in the slot points to a copied object, the corresponding new copy is looked up, and the slot is changed to contain a pointer to the new copy (807). Updating the thread-local slots is performed by the register, stack, global variable updater (124). (808) illustrates the end of the operation.

After updating the referring pointers, the execution of mutators is resumed (213).

It is possible to parallelize some of the operations performed during finalization. For example, each mutator thread could update its thread-local slots as soon as it detects that it should stop for finalization, thereby performing these updates in parallel by the mutator threads. Global variable update can begin as soon as the last mutator (excluding mutators in blocking calls) stops executing normal mutator code. Remembered set updating can begin as soon as the first mutator stops for finalization. If the references via remembered sets have been precomputed, updating the precomputed addresses can begin as soon as the last mutator stops for finalization (assuming the updater checks that each address still contains a pointer to a copied object), and any new referring pointers added in the last remembered set update (during finalization) can then be processed separately as soon as remembered set update is complete.

The part of finalization that is likely to take the longest time is updating referring pointers. Its duration can be reduced by precomputing the updates and dividing them to several threads, optimizing locality (to minimize TLB misses), and optimizing NUMA affinity. Also, the use of popular objects can greatly reduce the maximum number of referring pointers that may need to be updated.

Updating stack slots is often mentioned as a potentially lengthy operation in the literature. In principle it can be so, but in a threaded environment, stack sizes are usually limited and the maximum depth of recursion in applications needs to be limited anyway. Thus, updating the stack slots is not expected to be a practical problem, and in any case can be performed in parallel by the threads that were executing the mutators (and presumably have the top part of their own stack already in cache).

Experience from practical applications suggests that the stop-the-world pause times for most applications are likely to be under a millisecond or at most a few milliseconds.

At the end of the finalization, the old nursery is unused and can be freed. Also, any regions that became empty as a result of moving objects away from them (by copying) can be freed.

### Remembered Set Update

Remembered sets are used for quickly finding any memory locations that may reference objects in a particular region, enabling regions to be collected independently. Many varieties of remembered sets have been described in the literature, including inter-area pointers in P. Bishop: Computer Systems with a Very Large Address Space and Garbage Collection, PhD Thesis, MIT/LCS/TR-178, MIT, 1977 (also available as NTIS ADA040601); remembered sets in a generational collector in D. Ungar: Generation Scavenging: A Non-disruptive High Performance Storage Reclamation Algorithm, ACM SIGPLAN Notices, 19(5):157-167, 1984; remembered sets in the train collector in R. L. Hudson and J. E. B. Moss: Incremental Collection of Mature Objects, IWMM'92, Springer, 1992; remembered sets in a modern region-based collector in Detlefs et al (2004); and the various remembered set constructions described in the book by Jones and Lins (1996). Remembered sets have been implemented using, e.g., indirection pointers, hash tables, card tables, binary trees, and combinations thereof.

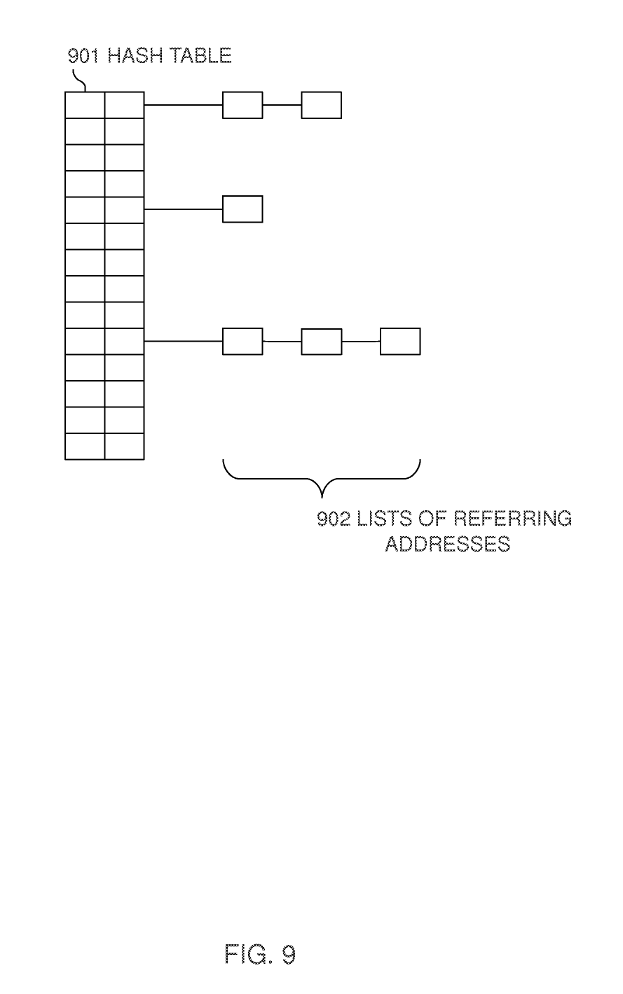

FIG. 9 illustrates a possible implementation of remembered sets. A hash table (901) is associated with each normal region. The hash table is keyed by the address of the referenced object, and the value corresponding to the key is a list (902) of memory addresses in other regions containing a pointer to the memory address used as the key.

After a pointer value pointing to a region is written to an object in another region, the address of the written location is added to the remembered set of the first region. The old value of the cell, if it was a pointer, is first removed from the remembered set of the region where it pointed to.

When an object is copied (moved), the list of referring addresses is moved from the hash table of its old region to the hash table of the region containing the new copy.

When an object becomes free, it (and its list) is removed from the hash table. (An object can become free even if it has a non-empty list, e.g., if it is part of a garbage cycle spanning multiple regions.)

If the list becomes free, the key can be removed from the hash table.

As an alternative to a hash table, any index structure (e.g., a tree) could be used. As an alternative to a list, any data structure for representing a set could be used. A binary search tree or hash table keyed by the referring address, for example, would allow fast deletions of addresses even if the set is large. It is also possible that the representation of the set changes depending on its size (e.g., directly in the remembered set hash table (901) if it contains only one address, linked list if it contains only a few items, and a second hash table or tree if it is larger).

In some embodiments the number of addresses stored for each referenced object may be maintained separately (e.g., in a field in the hash table (901)), so that identification of popular objects can be implemented efficiently without needing to iterate over the addresses. The copy planner can allocate space for objects with many references from a popular object area.

In most embodiments, the garbage collector does not normally track writes to the nursery. This is desirable, because in most applications most writes are to the nursery, and references from the nursery to older objects can be found when determining liveness for or copying the objects in the nursery.

As objects are copied, if there is a pointer between two copied objects and they end up in different regions, the address of the pointer will need to be added in the remembered set of the region containing the referenced object.

For objects in the old nursery, references to other copied objects do not need to be recorded anywhere, as they will be updated during (or after) copying. However, pointers from those objects to objects in other regions will need to be added to the remembered sets. Such a pointer may be discovered during liveness analysis or copying, and may be added to remembered sets as they are found or any time after their discovery during the garbage collection cycle. It is also possible to group such pointers to sets based on the region they refer to, and then use several threads to add them to the respective regions a set at a time (avoiding the need to synchronize additions to the same region by multiple threads).

Objects in the old nursery may also contain references to the new nursery. Such references must have been created during the garbage collection cycle (because the new nursery did not exist before the garbage collection cycle started). Such references will be tracked by the write barrier, and as the remembered sets are updated based on the values tracked by the write barrier, such references can be added to a special remembered set maintained for the new nursery (a single remembered set may be used for the entire new nursery, even if it comprises more than one region, or separate remembered sets might be maintained for each new nursery region).

Pointers to objects in the new or old nursery may also be written to memory locations in objects in older regions during the garbage collection cycle. In each case the address containing the referring pointer is added to the remembered set of the appropriate region.

Different garbage collectors differ in their requirements for remembered sets. For example, generational and train collectors generally only maintain remembered sets for pointers from older objects to younger objects. It is easy to adapt the remembered set maintenance for such garbage collectors. Such garbage collectors would also be reflected in the selection of the objects of interest and the set of objects to copy, placing constraints on the selection (e.g., forcing all younger objects to be included if any older object is included).

One tricky issue in remembered set maintenance is that as mutators run concurrently with the garbage collection cycle, they may add references to the copied objects in the new nursery. These pointers will also need to be updated to refer to the new copies during finalization. Thus, while it is in general not necessary for the write barrier to track writes to the new nursery, it should track writes to the new nursery where the value is a copied object. (Other approaches are also possible, such as tracing the new nursery before and/or during finalization, but such approaches would likely incur higher overhead.)

One possible approach for implementing the write barrier is illustrated by the code snippet below. This approach is based on having a table describing the status of each region (here called ‘status[ ]’, with 0 indicating new nursery region, 1 old nursery region or old region from which objects are being copied, 2 any old region that is not being copied, and 3 popular object/constant region):

int addr_idx = (written_addr − regions_base) >>

region_size_shift;

int st = status[addr_idx];
if (st == 1) /* write to object being copied? */

record_written_object(written_obj);

int value_idx = (new_value − regions_base) >>

region_size_shift;

int valst = status [value_idx];
if (st == 0) /* write to new nursery? */

{

if (valst == 1)

record(written_addr, NULL);

return;

}

/* write to old region */
int oldvalue_idx = (old_value − regions_base) >>

region_size_shift;

int oldvalst = status [oldvalue_idx];
if ((valst != 3 && addr_idx != value_idx) ||

oldvalst != 3)

record(written_addr, old_value);

In this sample write barrier illustration, record( ) adds the address to a thread-local write barrier buffer if it is not already there, with the second argument as its value. If the address is already there, its value is not changed. ‘written_addr’ is the address being written, ‘written_obj’ the object containing that address, ‘new_value’ the new value being written to the address, ‘old_value’ the old value of the address, ‘regions_base’ the address where the first region starts (which must be a multiple of region size), and ‘region_size_shift’ is base-2 logarithm of the size of a region. All regions are assumed to be of the same size (which must be a power of two).

The record_written_object( ) action adds the written object to a separate write barrier buffer. It is used for tracking which objects being copied have been written into during copying. This action should be performed also for non-pointer writes (e.g., for fields containing raw floating point numbers). The compiler would advantageously eliminate redundant multiple calls for the same object between GC points, as is known in the art.

Non-pointer values were not handled above, but should be treated as having ‘valst’ 3.

For global variables, a similar write barrier can be used, always treating global variables as having ‘st’ 2 and ‘addr_idx’ different from any normal region.

This write barrier is just illustrative, and many other kinds of write barriers could be used. For example, filtering could be done using address comparisons instead of arrays of region statuses. The region status arrays could be, e.g., character arrays, or could use two bits per region (in which case they could be 64-bit unsigned integer arrays, and accessing them could be something like “(status[(2 * idx)>>6]>>((2 * idx) & 0×63)) & 3”. The status could also be encoded in bit vectors, and accessed using special bit vector accessing instructions (e.g., the x86-64 architecture (Intel, AMD) has such instructions).

There is also a need to remove referring addresses from remembered sets when the referring objects get freed (typically when their containing region is freed at the end of a garbage collection cycle). Several alternatives exist for this. One possibility is to have with each region (except (new) nursery regions) an associated bitmap, with one bit per cell (cell expected to typically be 64 bits). This bitmap would have the corresponding bit set for each “external pointer”, that is, a pointer that points out from the region. The bitmap could be initialized when the object is copied, and maintained by the code that updates remembered sets. When a region is freed, the bitmap would be scanned to identify memory locations that contain external pointers, and such pointers could be removed from the remembered sets of the regions that they point to.

### Detecting Garbage Cycles Spanning Multiple Regions

It is well known in the art that in region-based garbage collectors there may be “garbage cycles”, that is, chains of objects spanning arbitrarily many regions. Any system that only inspects a subset of the regions at a time is at risk of not detecting such garbage cycles, and eventually running out of memory. For this reason, most region-based garbage collectors use some solution for detecting such cycles (see, e.g., Bishop (1977), Hudson and Moss (1992), and Detlefs et al (2004)).

One possible solution is to implement snapshot-at-the-beginning tracing for detecting such garbage cycles, similar to concurrent marking used in Detlefs et al (2004). The implementation illustrated here is just one possible embodiment.

The snapshot-at-the-beginning global tracing could work as follows. Each region is assumed to have an associated mark bitmap containing a bit for each possible object start position (e.g., one bit per 16 bytes if 16 byte alignment is used for objects). There is also a stack for the tracer (for simplicity, it is assumed that the size of the stack can grow without limit). Various ways of reducing the required stack size are known in the art. Free regions may also be used for storing the tracing stack. Some regions, for example, those used for large objects, could have a hash table instead of bitmap used for marking (and possibly recording object sizes).

At the beginning of a garbage collection cycle, it is decided that tracing is to start. It is assumed that the bitmaps have been cleared (e.g., by a background thread) after the previous global tracing completed (alternatively, bit polarity may be reversed, implicitly clearing (most of) the bitmaps). As roots are conservatively extracted at the beginning of the garbage collection cycle, each root (except those coming from remembered sets) is also added to the tracer's stack and the corresponding bit is marked (if the root has already been marked, it need not be re-added).

During liveness analysis for a garbage collection cycle where global tracing starts, each pointer from objects in the (old) nursery to objects in other regions is pushed to the tracer's stack and marked, if not already marked.

During tracing, the write barrier is used for collecting old values of all written memory locations (except those residing in the new nursery). Whenever the write barrier buffers for remembered set maintenance are processed, any old pointer values therein are pushed to the tracer's stack and marked if they (the corresponding objects) have not already been marked.

As objects are copied (or re-copied), if the object is copied from the nursery, it is marked. Otherwise, its mark is copied from the old copy to the new copy. To avoid concurrency control issues, the global tracing is advantageously stopped while a garbage collection cycle runs.

The tracer runs in parallel with mutators, except during times when a garbage collection cycle is executing. During each garbage collection cycle while global tracing is in progress, old values from the write barrier are added to the tracer's stack as described above (assuming they have not yet been traced).

When updating references in (212), any references from the tracer's stack to copied objects are updated to refer to the new copies. Alternatively, the copy locator (117) may be made available to the tracer, and it can update its own stack when it resumes after the garbage collection cycle, or it may translate pointers as they are popped from the stack based on saved copy locator(s).

The tracer is complete when its stack is empty at the end of a garbage collection cycle. Then, in parallel with mutators (but not in parallel with a garbage collection cycle or a remembered set update), it iterates over the remembered sets of all regions. For each object in the remembered sets (the key of the hash table), it checks if that object is marked. If it is not, that remembered set entry is removed (i.e., the key and its associated list are removed from the hash table). Corresponding bits indicating external pointers may also be cleared. (Other kinds of remembered set implementations would implement the details differently.)

It is possible to interrupt the final phase of global tracing for another garbage collection cycle or remembered set update, if necessary, as long as the iteration over the remembered set for the region currently being inspected is either not affected or is restarted after the interrupt.

The rationale is that if any of the pointers referring to an object is reached during the tracing, then the object will also be reached. In a garbage collection cycle, none of the objects in it are ever reached, and thus the remembered set entries keeping it alive get removed. The objects making up the garbage cycle will therefore get removed the next time their respective regions are collected.

At the end of global tracing it is also possible to estimate how much space is currently in use in each region by looking at the live objects in the region (the mark bits indicate where live objects start, and their sizes can be read from their headers in many embodiments). Alternatively, when an object is marked, all bits representing addresses contained in the object could be set, and the space used in the region could be determined by counting the bits. A further option is to have a used space field in a region header, initialize this field to zero at the start of tracing, and as each object is marked, add its size to this field in the region header. There could be two such fields, one from the previous tracing (which could be used for selecting regions for collection), and another one used for counting while tracing. Regions that are allocated during tracing would have their fields set at as space is allocated from them by the copy planner.

It may also be advantageous to scan the external pointer bitmaps of any regions whose amount of free space changes as a result of global tracing, and for any bits in the external pointer bitmap that are not part of a live object remove the reference from the remembered sets of the region pointed to.

The global tracing can also detect popular objects that are no longer accessible. Such popular objects will not have their corresponding bit set, and can be freed. However, this still does not provide a means for moving popular objects, and thus a freelist based allocation (mark-sweep garbage collection, essentially) could be used for the popular object area. It may be advantageous to round sizes of objects in the popular object area up to, e.g., powers of two, to reduce fragmentation.

### Implementation as a Distributed Garbage Collector

Some embodiments of the garbage collector described herein can also be adapted to distributed garbage collection, especially for systems utilizing distributed shared memory (i.e., where all nodes share the same virtual address space and identify an object using its virtual address, as opposed to systems using stubs, scions, and/or delegates for distributed objects).

A “node” refers to a (non-distributed) computer that is part of a distributed computer. Each node may have several processors connected by (hardware-based) shared memory (possibly using a NUMA architecture). There is no (hardware-based) shared memory between nodes (or if there is, it is significantly slower to access than the memories internal to a node). (The word is intended to have its ordinary meaning in distributed systems. A distributed system is a kind of distributed computer, which is a kind of computer. For the purposes of this disclosure the distributed system is limited to being accessing the same knowledge base or working co-operatively on the same problems or user requests.)

The term “NUMA node” is different, and refers to a subdivision of main memory having uniform access time characteristics (typically each NUMA node being “closer” to some processing cores than others, e.g., reflecting the difference between memory connected directly to a processor chip vs. memory connected to another processor chip and accessible through an interconnection fabric between the processors).

This description assumes reliable communications between the nodes and that packets sent by a node are received by each recipient node in the order in which they are sent. Implementation of such communications protocols is known in the art of distributed computing.

Applications in semantic information processing, semantic search, social networks, and in general large knowledge processing systems are likely to have extremely large knowledge bases (many terabytes, or even petabytes; many billions of objects). It is not practical to use delegates, stubs, and/or scions for remote objects in such systems. Instead, it is important to be able to replicate objects, migrate them between nodes, and to perform garbage collection efficiently in such a system.

The garbage collection method described in FIG. 1 can be adapted for distributed garbage collection as follows (several other alternative embodiments can also be recognized by one skilled in the art).

Each region is associated with a home node that has an authoritative copy of the region (in a fault tolerant system, this would be a set of nodes each of which has an authoritative copy). It is assumed that each node is capable of mapping a memory address to a region and to a containing node (the containing node could be stored in an array indexed by a region number or could be determinable from the memory address, e.g., by letting higher-order bits of the region number be a node number).

Each node is assumed to have its own nursery regions (however, the nursery regions may be accessible to other nodes).

Each node maintains remembered sets of references to each of its regions. Such references may be from objects in its local regions or from regions at remote nodes. In each case, the referring node can be determined from the address of each referring pointer in the remembered sets.

Whenever remembered sets are updated locally on a node based on data collected by its write barrier, any updates to remembered sets of regions on remote nodes are sent to the home node of the region. At certain points (as described below), certain synchronizations are used to ensure that all updates have been properly received and processed. (It may also be advantageous for all nodes that have a copy of a region to maintain remembered sets for it.)

When a garbage collection cycle starts, all nodes are notified of the start of the cycle. Each node then begins extracting roots and performing liveness analysis. If any remembered set updates are received during this time, any new remembered set entries pointing to objects of interest are added as roots (in addition to being processed normally as remembered set updates). Each node acknowledges to the node sending the remembered set update when the update has been processed (by sending a suitable message to it).

When a node completes liveness analysis (its stack is empty), and has received acknowledgements for all remembered set updates it has sent so far, it sends a message to all other nodes (possibly using a broadcast/multicast) to that effect. If it later receives a further remembered set update containing a new root, it will send a notification about continuing to all other nodes and continue liveness analysis.

If a node has itself completed liveness analysis, and has received a notification from all other nodes that they have completed liveness analysis (without later notifications about continuing), then all nodes have completed liveness analysis (reaching the end of box (203)).

Each node will select its own nursery regions as the regions of interest. Additionally, each node may select one or more regions owned by itself or by other nodes for collection. (It is also possible to only select some objects from a region.) No two nodes must select the same object (i.e., if two nodes select from the same region, they must select different objects therefrom).

One way to select the regions is for each node to select only regions for which it is the home node. However, this does not support migration. One way to negotiate migration is to send a request to a region's home node requesting that the requester be permitted to collect that region. The home node may then grant or reject the request, or grant it partially (for some objects; the request could also be only for some objects). The request and response could be sent during root extraction and liveness analysis, or it could have been sent even earlier (before the garbage collection cycle began), requesting permission for the next garbage collection cycle. A home node might also propose migration to another node (e.g., because most references in the region's remembered set are from that node), and the other node could accept or reject the migration request.

It is assumed that each region being collected that is owned by a remote node will first be copied as-is (i.e., replicated) to the node that is going to collect it, if it does not already have a replica. The replica might be sent immediately after accepting/granting permission to copy the region. Collection should not start until data for the region has been received.

The region may be transmitted over the network in compressed form, and only those objects that were marked as live in the last global tracing need to be transmitted (unless objects have been added to the region since the last global tracing). The techniques described in the U.S. patent application Ser. No. 12/360,202 “Serialization of shared and cyclic data structures using compressed object encodings” may be used for the compression, with pointers pointing out from the region encoded as-is, or, e.g., by reference to a previously sent pointer value.

Note that mutators on any number of nodes may be using (reading, writing) regions that are being garbage collected, simultaneously with the collection, each using its own replica of the page. (To implement distributed shared memory, various mutual exclusion and memory barrier techniques are likely to be used, with fine-grained or coarse-grained synchronization of updates, as is known in the art, particularly that dealing with distributed mutual exclusion and consistency issues in distributed shared memory—extensive published research in the area took place in the mid-1990s.)

The nodes will advantageously be made to share information about all the regions being collected by any node (in part, e.g., by broadcasting the answers to requests/proposals). Each node can then cause its write barrier to track written objects for any of the regions being collected by any node.

Each node can then perform copying in the normal way. If a node writes to an object residing in a different node, when it is determining the objects to re-copy, it will send information about any written remote object to the home node of the region containing the object (which may forward it to a node collecting it; alternatively, the information could be sent directly to the node collecting it), together with the new value of the written memory location.

After a node has determined the destination address of each object to be copied (i.e., constructed the copy locator (117)), it sends a copy of its copy locator to all other nodes (alternatively, it might, e.g., send only information for those objects known to have external references and rely on other nodes separately requesting information for any referring pointers that are detected only during the finalization stage).

It may be advantageous to wait for all nodes to report remote written objects before starting each re-copy. Each node will re-copy those objects that it is collecting that have been written into by any node.

When each node reaches (210), it sends a notification to that effect to other nodes (without yet stopping all of its mutators). When all nodes have reached that point (detected by having the notification from all other nodes), each node stops its mutators, and sends information to other nodes about any written objects that still need re-copying. Even if there are no objects to re-copy on a node, a notification to that effect is sent to that node.

As each node updates references in (212), it will update references for both objects copied by itself and for objects copied by any other node. If other nodes did not send complete copies of their copy locators, then requests may be sent in this stage to the respective other nodes for any pointers to the regions being copied by them for the new locations of the referenced objects (such new references appearing during the collection cycle should be fairly rare). They then wait for responses to such requests before completing referring pointer update.

As each node receives notifications about objects to re-copy, it will re-copy those objects in the notification that have not already been re-copied during the finalization stage (the copying may take place any time before executing (213)). As the thread reaches (213), it will wait until it has received the notification about objects to re-copy from all other nodes, and has performed the indicated re-copying, and only then resumes from (213), and the collection cycle is complete.

Stand-alone remembered set updates (711) may be performed locally, sending remembered set updates to other nodes asynchronously (they will be processed before the next collection cycle starts because of the synchronization there).

When properly implemented the illustrated distributed garbage collection scheme should be able to handle arbitrarily large object graphs. Even though each node will start a stop-the-world pause at the same time in the above description, that pause is very short (even if locations of new copies are requested from a remote node, such requests may be replied to in microseconds at today's interconnect speeds and latencies). The overall stop-the-world pause would probably only last some milliseconds.

Detection of garbage cycles spanning multiple regions (and possibly multiple nodes) may be performed in any of a number of ways. The distributed garbage collection literature abounds with descriptions of various distributed tracing algorithms, and the snapshot-at-the-beginning tracing algorithm described above could be extended to implement distributed tracing. A person skilled in the art of distributed garbage collection should be able to implement such extension. See S. Abdullahi et al: Collection Schemes for Distributed Garbage, IWMM'92, pp. 43-81, Lecture Notes in Computer Science 637, Springer-Verlag, 1992, which is hereby incorporated herein by reference, and references therein.

An alternative approach would be to perform local SATB tracing at each node to determine which pointers going out from the node are reachable from which entries to the node, effectively compressing or summarizing the local object graph into an in-out mapping. The compressed mappings could then be sent to one of the nodes for performing global transitive closure computation, or a distributed transitive closure computation could be used. For more information, see L. Veiga and P. Ferreira: Asynchronous, Complete Distributed Garbage Collection, Technical report RT/11/2004, INESC-ID/IST, Lisboa, Portugal, 2004 (updated 2005), which is hereby incorporated herein by reference.

### Miscellaneous

The term copying garbage collector includes garbage collectors that move objects to new memory areas, compacting garbage collectors (e.g., those using mark-and-sweep with compaction), distributed garbage collectors that support object migration, and garbage collectors for persistent systems that copy objects to/from non-volatile storage.

While the invention has been described primarily in the context of a (region-based) copying collector, it would also be possible to use it in a (primarily) mark-and-sweep or a reference counting collector with compaction. In such collectors, the invention would likely be beneficial especially if they sometimes compact (i.e., copy/move) objects, migrate them to another node in a distributed system, replicate them to more than one node in a distributed system, or implement persistence by maintaining one or more copies of at least some of the objects on disk or other non-volatile storage. In such collectors, the mark-and-sweep or reference counting aspect could be part of the liveness analyzer (and especially with reference counting, also part of mutator execution), and objects could be freed in the sweep phase (e.g., putting them on a freelist or marking them in a free bitmap) or as their count reaches zero during mutator execution. The literature, including some of the references incorporated herein, contain detailed descriptions of mark-and-sweep and reference counting methods.

While the description discusses copying as if it was between two memory locations in the main memory (102), either the source or the destination location or both could reside in some other type of memory, such as non-shared remote memory on a different node in a distributed system (typically accessible through the network (104)), non-volatile storage on a non-volatile storage device (typically part of the I/O subsystem (103)), or some other kind of memory. The memory could also be part of a distributed shared memory implementation. Mutators and/or the garbage collector could also utilize transactional memory.

Many variations of the above described embodiments beyond those mentioned above will be available to one skilled in the art. In particular, some operations could be reordered, combined, or interleaved, or executed in parallel, and many of the data structures could be implemented differently. When one element, step, or object is specified, in many cases several elements, steps, or objects could equivalently occur. Steps in flowcharts could be implemented, e.g., as state machine states, logic circuits, or optics in hardware components, as instructions, subprograms, or processes executed by a processor, or a combination of these and other techniques.

It is to be understood that the aspects and embodiments of the invention described in this specification may be used in any combination with each other. Several of the aspects and embodiments may be combined together to form a further embodiment of the invention, and not all features, elements, or characteristics of an embodiment necessarily appear in other embodiments. A method, an apparatus, or a computer program product which is an aspect of the invention may comprise any number of the embodiments or elements of the invention described in this specification. Separate references to “an embodiment” or “one embodiment” refer to particular embodiments or classes of embodiments (possibly different embodiments in each case), not necessarily all possible embodiments of the invention. The subject matter described herein is provided by way of illustration only and should not be construed as limiting. Captions are only intended to help the reader and should not be interpreted as limiting.

Stop-the-world synchronization (node-local or cluster-wide in a distributed system) could be used instead of soft synchronization for some or all synchronizations without sacrificing correctness but such approach would usually incur additional overhead.

A pointer should be interpreted to mean any reference to an object, such as a memory address, an index into an array of objects, a key into a (possibly weak) hash table containing objects, a global unique identifier, or some other object identifier that can be used to retrieve and/or gain access to the referenced object. In some embodiments pointers may also refer to fields of a larger object.

In this specification, copying was described as being within the local memory of a computer. However, in a distributed system, copying may be to a another node in the distributed system. In such embodiments, the copying may be implemented using messages over an interconnection network (part of the network (104)). Another aspect of copying in such environments is receiving the copy at the other node and storing it in memory at the desired address. In such systems, memory allocation from regions residing at the remote node may involve sending allocation requests to the other node. Copying as described herein may therefore be used for implementing object migration from one node to another.

In this specification, selecting has its ordinary meaning, with the extension that selecting from just one alternative means taking that alternative (i.e., the only possible choice), and selecting from no alternatives either returns a “no selection” indicator (such as a NULL pointer), triggers an error (e.g., a “throw” in Lisp or “exception” in Java), or returns a default value, as is appropriate in each embodiment.

Computer-readable media can include, e.g., computer-readable magnetic data storage media (e.g., floppies, disk drives, tapes), computer-readable optical data storage media (e.g., disks, tapes, holograms, crystals, strips), semiconductor memories (such as flash memory and various ROM technologies), media accessible through an I/O interface in a computer, media accessible through a network interface in a computer, networked file servers from which at least some of the content can be accessed by another computer, data buffered, cached, or in transit through a computer network, or any other media that can be accessed by a computer. Non-transitory computer readable media include all computer readable media except for transitory, propagating signals.

It should be understood that garbage collection is a highly specialized and complex subfield of software engineering, with thousands of research papers published and probably over a hundred PhD theses written in the field. It is also an art where experience makes a huge difference. One cannot be skilled in the art of garbage collection without having implemented at least some real-world garbage collectors. Incremental, real-time, and concurrent collectors are even more difficult, not to mention their distributed versions. Among other things, implementing such collectors requires a good understanding of concurrent programming, computer architecture, and memory consistency issues. A skilled person in the art has at least some experience from such collectors, as most modern collectors for real-world applications (e.g., high-performance Java virtual machines) are by practical necessity concurrent, incremental, and/or more or less soft real-time.

What is claimed is:

1. A method of implementing a write barrier for an application supported by a garbage collector that supports multiple independently collectable memory regions, comprising:
computing, in a write barrier operation performed by a processor, a region index for the memory region containing an object from a pointer to the object;
reading a region status from a region status array using the region index to select which region's status is read; and
using the region status to determine further actions taken by a write barrier.

2. The method of claim 1, wherein the further actions taken by the write barrier comprise, for at least one write performed by a mutator, an action selected from the following:
saving the written address for later re-copying;
saving a pointer to the written object for further re-copying;
computing a region index for the new value written to an address in the nursery, reading its region status, and if the status indicates that the new value points to an object being copied, triggering updating of the value of the written memory location to point to the new copy of the corresponding object;
causing an object to be visited by a concurrent tracer for implementing snapshot-at-the-beginning marking;
triggering propagation of a write to another node in a distributed shared memory system; and
triggering updating of a remembered set entry relating to a pointer in a mature region.

3. The method of claim 1, further comprising:
in the beginning of a garbage collection cycle, changing the status of all regions that were part of the nursery before the garbage collection began to indicate that they are regions of interest; and
during liveness analysis and copying in the garbage collector, assigning to new nursery regions a region status that distinguishes them from regions of interest and from mature regions.

4. The method of claim 1, further comprising:
assigning a special region status for regions containing popular objects, the status indicating that no remembered sets need to be maintained for pointers from other regions to objects in the regions containing popular objects, and skipping remembered set entry creation where the new value of a written pointer points to a popular object.

5. The method of claim 1, further comprising:
in the liveness analyzer, while tracing an object and analyzing a pointer contained in the object, computing a region index from the pointer, reading the corresponding region status from the region status array, and if the region status indicates that the pointer points to an object that is not in a region of interest, skipping that pointer without tracing it.

6. The method of claim 1, wherein the region status array is configured to be small enough to allow at least 95% of accesses to the region status array to be performed without accessing memory outside the processor performing the access.

7. An apparatus comprising:
a region status array stored in a memory device, the region status array permitting a region status to be read from it using a region index to select which region status to read;
a processor implementing a write barrier, the write barrier configured to compute a region index from a written address and connected to the region status array for reading the region status corresponding to a region index; and
at least one write barrier action element connected to the write barrier and activated by the region status matching a predetermined value, the action element selected from the group consisting of:
a write tracker for triggering re-copying of objects that have been written into during copying;
a write tracker for triggering a liveness analyzer to trace the old value of a written memory location; and
a write tracker for triggering a pointer in the nursery pointing to an object being copied to be updated to point to the new copy of the object.

8. A computer program product comprising:
computer executable instructions stored on a non-transitory computer-readable medium for computing a region index from a pointer to an object;
computer executable instructions stored on a non-transitory computer-readable medium for reading a region status from a region status array using the region index; and
computer executable instructions stored on a non-transitory computer-readable medium for using the region status to determine further actions taken by a write barrier.

9. The computer program product of claim 8, further comprising computer executable instructions stored on a non-transitory computer-readable medium for triggering, by the write barrier, a written memory location in an object being copied to be re-copied after the initial copying is complete.

10. The computer program product of claim 8, further comprising computer executable instructions on a non-transitory computer-readable medium for causing, by the write barrier, pointers to objects being copied written to nursery memory regions during a garbage collection cycle to be updated to point to the new copies of the respective objects.

11. The computer program product of claim 8, further comprising computer executable instructions on a non-transitory computer-readable medium for queueing, by the write barrier, a write to be propagated to at least one node in a distributed system besides the node on which the write barrier executes.
